(19) United States
(12) Patent Application Publication
(10) Pub. No.: US 2024/0231250 A1
(43) Pub. Date: Jul. 11, 2024

(54) TONER FOR USE IN IMAGE-FORMING

(71) Applicant: CANON KABUSHIKI KAISHA, Tokyo (JP)

(72) Inventors: KAZUYUKI SATO, Kanagawa (JP); TOMOHISA SANO, Shizuoka (JP); TOHRU HIRAMATSU, Shizuoka (JP); ATSUHIKO OHMORI, Kanagawa (JP); KOSUKE FUKUDOME, Tokyo (JP); HIROKI KAGAWA, Shizuoka (JP)

(21) Appl. No.: 18/544,218

(22) Filed: Dec. 18, 2023

(30) Foreign Application Priority Data
Dec. 27, 2022 (JP) 2022-209745
Nov. 28, 2023 (JP) 2023-200925

(51) Int. Cl. G03G 9/097; G03G 9/08

(52) U.S. Cl. CPC G03G 9/09716; G03G 9/0819

(57) ABSTRACT

A toner containing: a toner particle containing a binder resin; and an external additive, wherein a peak corresponding to boric acid is detected in ATR-IR analysis of the toner particle using germanium as an ATR crystal in an ATR method, the external additive contains a hydrophobized fine alumina particle produced by surface-treating a fine alumina particle, which is a fine base particle, with a hydrophobic treatment agent, the hydrophobized fine alumina particle has a hydrophobicity of 50 or more and 90 or less, the hydrophobized fine alumina particle has a volume resistivity of 1.0×10⁸ Ω·cm or more and 1.0×10¹² Ω·cm or less, and a rate of atoms originated from the fine base particle in the hydrophobized fine alumina particle is 30 atomic % or more and 70 atomic % or less.

### BACKGROUND

### Field of the Disclosure

The present disclosure relates to a toner for use in an image-forming method, such as electrophotography.

### Description of the Related Art

An electrophotographic technique is a technique of forming an electrostatic latent image on a uniformly charged photosensitive member and visualizing image information using charged toner and is used in devices, such as copying machines and printers. In recent years, to cope with various usages of copying machines and printers, it has been required to extend the life and to obtain a high-quality image in any environment.

Japanese Patent Laid-Open No. 2018-163209 discloses a toner containing an external additive in which the type and the volume resistivity of a surface treatment agent are specified. Excessive charge-up of toner in a low-temperature and low-humidity environment can be reduced to form a high-quality image.

Japanese Patent Laid-Open No. 2019-200345 discloses a toner for which alumina with a defined volume resistivity is used as an external additive and that has a defined abundance ratio of aluminum atoms on the toner surface. Electrical charges held by toner can be sufficiently discharged at the time of fixing the toner to prevent sticking between recording media.

In a toner according to Japanese Patent Laid-Open No. 2018-163209, the charge-up of the toner can be reduced in a low-temperature and low-humidity environment to reduce the occurrence of regulatory failure in which over-charged toner is fused to a toner carrier. A toner according to Japanese Patent Laid-Open No. 2019-200345 can have a predetermined effect in a normal temperature and humidity environment.

However, in a series of processes of image formation, in a high-temperature and high-humidity environment, a low-charged toner is easily generated in a developing process, and transferability is lowered by charge decay due to a transfer bias in a transfer process.

### SUMMARY

For the reasons described above, the present disclosure provides a toner with high transferability by reducing the occurrence of regulatory failure in a low-temperature and low-humidity environment and reducing the occurrence of a low-charged toner in a developing process and charge decay in a transfer process in a high-temperature and high-humidity environment.

The present disclosure relates to a toner containing: a toner particle containing a binder resin; and an external additive, wherein
a peak corresponding to boric acid is detected in ATR-IR analysis of the toner particle using germanium as an ATR crystal in an ATR method,
the external additive contains a hydrophobized fine alumina particle produced by surface-treating a fine alumina particle, which is a fine base particle, with a hydrophobic treatment agent,
the hydrophobized fine alumina particle has a hydrophobicity of 50 or more and 90 or less,
the hydrophobized fine alumina particle has a volume resistivity of 1.0×10⁸ Ω·cm or more and 1.0×10¹² Ω·cm or less, and
a rate of atoms originated from the fine base particle in the hydrophobized fine alumina particle is 30 atomic % or more and 70 atomic % or less.

Further features of the present disclosure will become apparent from the following description of exemplary embodiments.

### DESCRIPTION OF THE EMBODIMENTS

Unless otherwise specified, the numerical range “XX or more and YY or less” or “XX to YY”, as used herein, refers to the numerical range including the lower limit and the upper limit. For stepwise numerical ranges, the upper limit and the lower limit of each numerical range may be arbitrarily combined.

### Features of Present Disclosure

It is known that the use of fine particles with a lower volume resistivity than fine silica particles as an external additive for toner can suppress charge-up of the toner and thereby suppress regulatory failure in a low-temperature and low-humidity environment.

In a high-temperature and high-humidity environment, however, it is difficult to sufficiently charge toner in a developing process in an image-forming process, and electrical charges on the toner particle surface decay easily in a transfer process in the image-forming process, so that there is a problem that the transferability is lowered due to the shortage of the amount of electrical charge on each toner. This problem could not be solved only by increasing the hydrophobicity of an external additive.

As a result of extensive studies, the present inventors have found that external addition of hydrophobized alumina with controlled hydrophobicity, volume resistivity, and rate of atoms originated from the base to toner particles containing a boric acid component near the toner particle surface can dramatically improve the chargeability and charge retention in a high-temperature and high-humidity environment while suppressing charge-up in a low-temperature and low-humidity environment and thereby remarkably improve the transferability.

The present inventors consider the effect of improving the chargeability and charge retention and thereby improving the transferability as described below.

It is thought that boric acid in toner particles is cleaved by bonding with an OH group of a resin component contained in the toner particles in a toner particle production process, and exists as a cross-linking site near the toner particle surface as a borate ion BO₄⁻. The borate ion acts as a Lewis acid and increases the negative chargeability of the toner, but, due to a high affinity for water molecules, adsorbs water molecules in a high-temperature and high-humidity environment, and tends to reduce electrical charges on the toner surface. The external addition of hydrophobic alumina with an appropriately exposed base to the toner particles causes a strong interaction between a borate ion BO₄⁻ and Al on the surface of alumina, which is a homologous element thereof, and, together with the hydrophobic effects of alumina, can significantly reduce the adsorption of water molecules.

In the developing process, charge transfer to the toner particle surface occurs through fine alumina particles with low resistivity, thus resulting in high chargeability. On the other hand, in the transfer process, electrical charges are retained on the toner particle surface on which water molecules are less adsorbed, thus resulting in high charge retention. It is thought that this increases the amount of electrical charge on the toner and results in very high transferability.

Next, the present disclosure is described in more detail.

### [Hydrophobized Fine Alumina Particles]

First, hydrophobized fine alumina particles for use in a toner according to the present disclosure are described.

The hydrophobized fine alumina particles for use in the present disclosure have a hydrophobicity of 50 or more and 90 or less. A hydrophobicity in this range can result in less adsorption of water molecules on the fine alumina particles and on borate ions interacting therewith. A hydrophobicity of less than 50 results in a smaller effect of reducing the adsorption of water molecules and consequently an insufficient effect of improving the charge retention. A hydrophobicity of more than 90 results in a weaker interaction between borate ions and fine alumina particles and consequently an insufficient effect of improving the chargeability. The hydrophobicity is preferably 60 or more and 85 or less.

The hydrophobized fine alumina particles for use in the present disclosure have a volume resistivity of 1.0×10⁸ Ω·cm or more and 1.0×10¹² Ω·cm or less. A volume resistivity in this range can result in less regulatory failure in a low-temperature and low-humidity environment and improved chargeability and charge retention in a high-temperature and high-humidity environment. A volume resistivity of less than 1.0×10⁸ Ω·cm results in charge decay on the toner particle surface and consequently an insufficient effect of improving the charge retention. A volume resistivity of more than 1.0×10¹² Ω·cm results in an insufficient effect of reducing regulatory failure in a low-temperature and low-humidity environment, less charge transfer to the toner particle surface in the developing process, and an insufficient effect of improving the chargeability. The volume resistivity is preferably 1.0×10¹⁰ Ω·cm or more and 5.0×10¹¹ Ω·cm or less.

The fine base particles of the hydrophobized fine alumina particles for use in the present disclosure have a rate of atoms originated from the fine base particles of 30 atomic % or more and 70 atomic % or less. The fine base particles with the rate in this range causes efficient interaction between borate ions and the fine alumina particles and charge transfer to the toner particle surface with less adsorption of water molecules, thereby improving the chargeability. The fine base particles with the rate of less than 30 atomic % produce an insufficient effect of improving the chargeability. The fine base particles with the rate of more than 70 atomic % cause the adsorption of water molecules on the alumina surface and consequently produce an insufficient effect of improving the charge retention. The fine base particles preferably have the rate of 35 atomic % or more and 65 atomic % or less.

The primary particles of the hydropbobized fine alumina particles for use in the present disclosure have a number-average particle diameter of 15 nm or more and 300 nm or less. The primary particles with a number-average particle diameter in this range can be prevented from being embedded in the toner particles and from being detached from the toner particles and can maintain stable transferability for extended periods. The primary particles preferably have a number-average particle diameter of 20 nm or more and 100 nm or less.

The hydropbobized fine alumina particles for use in the present disclosure have a carbon content of 0.5% by mass or more and 10.0% by mass or less. When the carbon content derived from the hydrophobic treatment agent is in this range, the rate of atoms originated from the fine base particles of the hydrophobized fine alumina particles can be suitably controlled. The carbon content is preferably 2.0% by mass or more and 6.0% by mass or less.

When the hydrophobized fine alumina particles for use in the present disclosure are left for 24 hours in an environment of a temperature of 30° C. and a relative humidity of 0% and are then left for 1 hour in an environment of a temperature of 30° C. and a relative humidity of 80%, the value (mass change rate/specific surface area) obtained by dividing the mass change rate of the hydrophobized fine alumina particles by the specific surface area of the hydrophobized fine alumina particles is preferably 0.005%·g/m² or more and 0.100%·g/m² or less. A mass change rate/specific surface area in this range can result in promoted charge transfer to the toner particle surface and consequently improved charge build-up in a high humidity environment. The mass change rate/specific surface area is preferably 0.010%·g/m² or more and 0.050%·g/m² or less.

The fine alumina particles, which are the base of the hydrophobized fine alumina particles, are not particularly limited. Alumina is produced by a method, such as a thermal decomposition method of ammonium aluminum carbonate, a gas-phase oxidation method, a deflagration method, a Bayer method, or a hydrolysis method of aluminum alkoxide, using transition alumina or an alumina raw material that becomes transition alumina by heat treatment. Transition alumina refers to any alumina other than a among polymorphic alumina represented by Al₂O₃. Specific examples include γ-alumina, δ-alumina, and θ-alumina.

The hydrophobic treatment agent to be used to produce hydrophobized fine alumina particles for use in the present disclosure is, for example, chlorosilane, such as methyltrichlorosilane, dimethyldichlorosilane, trimethylchlorosilane, phenyltrichlorosilane, diphenyldichlorosilane, t-butyldimethylchlorosilane, or vinyltrichlorosilane;
an alkoxysilane, such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, or γ-(2-aminoethyl)aminopropylmethyldimethoxysilane;
silazane, such as hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, or dimethyltetravinyldisilazane;
silicone oil, such as dimethyl silicone oil, methyl hydrogen silicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, or terminal reactive silicone oil,
siloxane, such as hexamethylcyclotrisiloxane, octamethylcyclotetrasiloxane, decamethylcyclopentasiloxane, hexamethyldisiloxane, or octamethyltrisiloxane; or
a fatty acid or a metal salt thereof, for example, a long-chain fatty acid, such as undecylic acid, lauric acid, tridecylic acid, dodecylic acid, myristic acid, palmitic acid, pentadecylic acid, stearic acid, heptadecylic acid, arachidic acid, montanic acid, oleic acid, linoleic acid, or arachidonic acid, or a salt of the fatty acid and a metal, such as zinc, iron, magnesium, aluminum, calcium, sodium, or lithium.

In particular, a silicon compound with a hydrocarbon moiety may be used. These compounds can be used as a hydrophobic treatment agent to control the volume resistivity of the hydrophobized fine alumina particles.

Among these compounds, dimethyl silicone oil or a silane compound represented by the following formula (1) may particularly be used.

(RO)₃Si(CH₂)ₙCH₃ (1)
R denotes a methyl group or an ethyl group, and n denotes an integer of 5 or more and 11 or less.

A silane compound represented by the formula (I) may be hexyltrimethoxysilane (R: CH₃, n: 5), hexyltriethoxysilane (R: C₂H₅, n: 5), octyltrimethoxysilane (R: CH₃, n: 7), decyltrimethoxysilane (R: CH₃, n: 9), dodecyltrimethoxysilane (R: CH₃, n: 11), or the like.

The silicone oil or the silane compound can be used to suitably control the rate of atoms originated from the fine base particles of the hydrophobized fine alumina particles.

These hydrophobic treatment agents may be used alone or in combination.

The treatment method of the hydrophobic treatment agent may be any method, including a known method, such as a dry method or a wet method.

The dry method includes spraying the hydrophobic treatment agent while mixing the fine alumina particles by stirring in a mixer, maintaining the mixing by stirring for a certain period, and then drying the hydrophobic treatment agent. The hydrophobic treatment agent can be diluted with a solvent, which may be water, an alcohol, toluene, or the like. A catalyst, such as an amine, ammonia, acetic acid, or hydrochloric acid, may be added.

The wet method includes dissolving a certain amount of the hydrophobic treatment agent in a solvent in which the fine alumina particles are dispersed, bringing the hydrophobic treatment agent into contact with the surface of the fine alumina particles, and then removing the solvent. The solvent may be water, an alcohol, toluene, or the like as in the dry method. A catalyst, such as an amine, ammonia, acetic acid, or hydrochloric acid, may be added.

The hydrophobized fine alumina particle content in the present disclosure is preferably 0.1 parts by mass or more and 5.0 parts by mass or less per 100 parts by mass of the toner particles. The content in this range results in sufficient interaction between borate ions and the fine alumina particles and consequently further improved transferability. The content is more preferably 0.2 parts by mass or more and 1.0 part by mass or less.

### [Boric Acid]

Next, boric acid for use in the toner particles in the present disclosure is described.

Boric acid may be incorporated into the toner particles by any method. For example, boric acid can be incorporated into the toner particles by internally adding boric acid to the toner particles or by using boric acid as an aggregating agent in an aggregation method. The addition of boric acid as an aggregating agent facilitates the introduction of boric acid in the vicinity of the toner particle surface. An organic boric acid, a borate salt, a borate ester, or the like may also be used as a raw material. When the toner particles are produced in an aqueous medium, from the perspective of reactivity and production stability, a borate acid may be added. Specific examples thereof include sodium tetraborate and ammonium borate, particularly borax.

Borax is a decahydrate of sodium tetraborate Na₂B₄O₇, which is converted into boric acid in an acidic aqueous solution, and borax may therefore be used in an aqueous medium in an acidic environment.

In X-ray fluorescence measurement of the toner particles, boron derived from boric acid preferably has an intensity of 0.10 keps or more and 0.60 kcps or less, more preferably 0.10 keps or more and 0.30 keps or less. In these ranges, the amount of boric acid in the vicinity of the toner particle surface is appropriate, and boric acid acting as a Lewis acid has high chargeability.

Furthermore, in the X-ray fluorescence measurement of the toner particles, aluminum may be contained, and 0.01 keps or more and 5.00 kcps or less is still more preferred. In this range, the interaction between borate ions and Al also works in the toner particles, and the adsorption of water molecules is further reduced to improve the charge retention.

The intensity of boron may be controlled in these ranges, for example, by adjusting the addition amount of a boric acid source at the time of producing the toner particles, and the boric acid content of the toner particles is preferably controlled to 0.1% by mass or more and 10.0% by mass or less. The boric acid content of the toner particles is more preferably 0.4% by mass or more and 5.0% by mass or less, still more preferably 0.8% by mass or more and 2.0% by mass or less.

The boric acid ratio in the vicinity of the toner particle surface can be estimated by the ratio I_{B}/I_{C} of a peak intensity Is at 1380 cm⁻¹ derived from boric acid to a peak intensity I_{C} at 1700 to 1750 cm⁻¹ derived from a carbonyl group of a binder resin in an infrared absorption spectrum. It is thought that hydrophobized fine alumina particles according to the present disclosure can interact not only with borate ions on the toner particle surface but also with a carbonyl group of a binder resin. When the I_{B}/I_{C} is 0.02 or more and 0.30 or less, sufficient interaction of the hydrophobized fine alumina particles with borate ions can promote the charge transfer to the toner particle surface and can therefore further improve the charge build-up in a high humidity environment. 0.10 or more and 0.20 or less is more preferred.

The peak intensity ratio may be controlled in these ranges, for example, by adjusting the pH after the addition of a boric acid source at the time of producing the toner particles. The amount of boric acid in the vicinity of the toner particle surface can be controlled by controlling the stability as a cross-linking site with a resin component near the toner particle surface by pH adjustment.

### [Components of Toner and Method for Producing Toner]

Components constituting toner and a method for producing toner are described below in more detail.

### <Binder Resin>

The toner particles contain a binder resin. The binder resin content is preferably 50% by mass or more of the total amount of resin components in the toner particles.

The binder resin is, but not limited to, for example, a styrene acrylic resin, an epoxy resin, a polyester resin, a polyurethane resin, a polyamide resin, a cellulose resin, a polyether resin, or a mixed resin or a composite resin thereof. A styrene acrylic resin or a polyester resin, particularly a polyester resin, is inexpensive, is readily available, and has good low-temperature fixability.

A polyester resin can be synthesized by combining suitable compounds selected from polycarboxylic acids, polyols, hydroxycarboxylic acids, and the like and by using a known method, such as a transesterification method or a polycondensation method. The polyester resin may include a condensation polymer of a dicarboxylic acid and a diol.

The polycarboxylic acids are compounds with two or more carboxy groups per molecule. Among them, dicarboxylic acids are compounds with two carboxy groups per molecule and are often used.

Examples thereof include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Examples of polycarboxylic acids other than the dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. These may be used alone or in combination.

Polyols are compounds with two or more hydroxy groups per molecule. Among these, diols are compounds with two hydroxy groups per molecule and are often used.

Specific examples thereof include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, 1,14-eicosanedecanediol, dipropylene glycol, poly(ethylene glycol), poly(propylene glycol), polytetramethylene ether glycol, 1,4-cyclohexanediol, 1,4-cyclohexanedimethanol, 1,4-butenediol, neopentyl glycol, poly(tetramethylene glycol), hydrogenated bisphenol A, bisphenol A, bisphenol F, bisphenol S, and alkylene oxide (ethylene oxide, propylene oxide, butylene oxide, etc.) adducts of the bisphenols.

In particular, alkylene glycols with 2 or more and 12 or less carbon atoms and alkylene oxide adducts of bisphenols, particularly alkylene oxide adducts of bisphenols and combinations thereof with alkylene glycols with 2 or more and 12 or less carbon atoms may be used. An alkylene oxide adduct of bisphenol A may be a compound represented by the following formula (A):

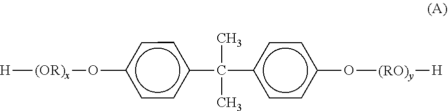

In the formula (A), R each independently denotes an ethylene or propylene group, x and y each denote an integer of 0 or more, and the average value of x+y is 0 or more and 10 or less.

The alkylene oxide adduct of bisphenol A can be a propylene oxide adduct and/or an ethylene oxide adduct of bisphenol A. In particular, it can be a propylene oxide adduct. The average value of x+y is preferably 1 or more and S or less.

Examples of trihydric or higher polyhydric alcohols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of trivalent or higher polyphenols. These may be used alone or in combination.

The styrene acrylic resin may be a homopolymer composed of the following polymerizable monomer, a copolymer composed of two or more of these monomers, or a mixture thereof.

A styrene monomer, such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, or p-phenylstyrene;
a (meth)acrylic monomer, such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethylphosphate ethyl (meth)acrylate, diethylphosphate ethyl (meth)acrylate, dibutylphosphate ethyl (meth)acrylate, 2-benzoyloxyethyl (meth)acrylate, (meth)acrylonitrile, 2-hydroxyethyl (meth)acrylate, (meth)acrylic acid, or maleic acid;
a vinyl ether monomer, such as vinyl methyl ether or vinyl isobutyl ether; a vinyl ketone monomer, such as vinyl methyl ketone, vinyl ethyl ketone, or vinyl isopropenyl ketone; or
a polyolefin, such as ethylene, propylene, or butadiene.

The styrene acrylic resin may be a polyfunctional polymerizable monomer, if necessary. The polyfunctional polymerizable monomer is, for example, diethylene glycol di(meth)acrylate, triethylene glycol di(meth)acrylate, tetraethylene glycol di(meth)acrylate, poly(ethylene glycol) di(meth)acrylate, 1,6-hexanediol di(meth)acrylate, neopentyl glycol di(meth)acrylate, tripropylene glycol di(meth)acrylate, poly(propylene glycol) di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, or divinyl ether.

To control the degree of polymerization, a known chain transfer agent and a known polymerization inhibitor may be further added. Examples of a polymerization initiator for producing a styrene acrylic resin include organic peroxide initiators and azo polymerization initiators.

Examples of the organic peroxide initiators include benzoyl peroxide, lauroyl peroxide, di-α-cumyl peroxide, 2,5-dimethyl-2,5-bis(benzoyl peroxy)hexane, bis(4-t-butylcyclohexyl)peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropyl peroxy carbonate, cumene hydroperoxide, 2,4-dichlorobenzoyl peroxide, and tert-butyl-peroxypivalate.

Examples of the azo polymerization initiators include 2,2′-azobis(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobismethylbutyronitrile, and 2,2′-azobis(methyl isobutyrate).

Furthermore, the polymerization initiator may be a redox initiator in which an oxidizing substance and a reducing substance are combined.

The oxidizing substance may be hydrogen peroxide, an inorganic peroxide of a persulfate salt (sodium, potassium, or ammonium salt), or an oxidizing metal salt of a tetravalent cerium salt.

The reducing substance may be a reducing metal salt (divalent iron salt, monovalent copper salt, or trivalent chromium salt), ammonia, a lower amine (amine with approximately 1 or more and 6 or less carbon atoms, such as methylamine or ethylamine), an amino compound, such as hydroxylamine, a reducing sulfur compound, such as sodium thiosulfate, sodium hydrosulfite, sodium hydrogen sulfite, sodium bisulfite, sodium sulfite, or sodium formaldehyde sulfoxylate, a lower alcohol (1 or more and 6 or less carbon atoms), ascorbic acid or a salt thereof, or a lower aldehyde (1 or more and 6 or less carbon atoms).

The polymerization initiator is selected with reference to the 10-hour half-life temperature and is used alone or in combination. The amount of the polymerization initiator to be added varies with the desired degree of polymerization and is typically 0.5 parts by mass or more and 20.0 parts by mass or less per 100.0 parts by mass of polymerizable monomer(s).

### <Release Agent>

In the toner, a known wax can be used as a release agent.

Specific examples thereof include petroleum waxes and their derivatives, such as paraffin waxes, microcrystalline waxes, and petrolatum, montan wax and its derivatives, Fischer-Tropsch hydrocarbon waxes and their derivatives, polyolefin waxes and their derivatives, such as polyethylene, and natural waxes and their derivatives, such as carnauba wax and candelilla wax. Examples of the derivatives include oxides, block copolymers with a vinyl monomer, and graft-modified materials.

Also included are alcohols, such as higher aliphatic alcohols; fatty acids, such as stearic acid and palmitic acid, and acid amides, esters, and ketones thereof; hydrogenated castor oil and derivatives thereof, plant waxes, and animal waxes. These may be used alone or in combination.

Among these, polyolefin, Fischer-Tropsch hydrocarbon waxes, and petroleum waxes tend to improve developability and transferability. An antioxidant may be added to these waxes without affecting the effects of the toner. From the perspective of the phase separation property with respect to the binder resin or the crystallization temperature, higher fatty acid esters, such as behenyl behenate and dibehenyl sebacate, can be suitably exemplified.

The release agent content is preferably 1.0 part by mass or more and 30.0 parts by mass or less per 100.0 parts by mass of the binder resin.

The release agent preferably has a melting point of 30° C. or more and 120° C. or less, more preferably 60° C. or more and 100° C. or less. A release agent with such thermal properties can be used to efficiently exhibit the release effects and ensure a wider fixing region.

### <Plasticizer>

The toner particles may contain a crystalline plasticizer to improve the sharp melt property. The plasticizer may be, but is not limited to, a known plasticizer for use in toner, as described below.

Specific examples thereof include esters of a monohydric alcohol and an aliphatic carboxylic acid and esters of a monovalent carboxylic acid and an aliphatic alcohol, such as behenyl behenate, stearyl stearate, and palmityl palmitate; esters of a dihydric alcohol and an aliphatic carboxylic acid and esters of a divalent carboxylic acid and an aliphatic alcohol, such as ethylene glycol distearate, dibehenyl sebacate, and hexanediol dibehenate; esters of a trihydric alcohol and an aliphatic carboxylic acid and esters of a trivalent carboxylic acid and an aliphatic alcohol, such as glycerin tribehenate; esters of a tetrahydric alcohol and an aliphatic carboxylic acid and esters of a tetravalent carboxylic acid and an aliphatic alcohol, such as pentaerythritol tetrastearate and pentaerythritol tetrapalmitate; esters of a hexahydric alcohol and an aliphatic carboxylic acid and esters of a hexavalent carboxylic acid and an aliphatic alcohol, such as dipentaerythritol hexastearate and dipentaerythritol hexapalmitate; esters of a polyhydric alcohol and an aliphatic carboxylic acid and esters of a polycarboxylic acid and an aliphatic alcohol, such as polyglycerin behenate; and natural ester waxes, such as carnauba wax and rice wax. These may be used alone or in combination.

### <Colorant>

The toner particles may contain a colorant. The colorant may be a known pigment or dye. From the perspective of high weatherability, the colorant may be a pigment. Examples of a cyan colorant include copper phthalocyanine compounds and derivatives thereof, anthraquinone compounds, and basic dye lake compounds.

Specific examples include C.I. Pigment Blue 1, 7, 15, 15:1, 15:2, 15:3, 15:4, 60, 62, and 66.

Examples of a magenta colorant include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specific examples include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of a yellow colorant include condensed azo compounds, isoindolinone compounds, anthraquinone compounds, azo metal complexes, methine compounds, and allylamide compounds.

Specific examples include C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of a black colorant include colorants adjusted to black using the yellow colorant, the magenta colorant, and the cyan colorant; carbon black; and magnetic materials. These colorants may be used alone or in combination or may be used in the form of solid solution.

The colorant is preferably used in an amount of 1.0 part by mass or more and 20.0 parts by mass or less per 100.0 parts by mass of the binder resin.

### <Charge Control Agent and Charge Control Resin>

The toner particles may contain a charge control agent or a charge control resin. The charge control agent may be a known charge control agent, particularly a charge control agent that has a high frictional charging speed and that can stably maintain a certain triboelectric charging amount. Furthermore, when the toner particles are produced by a suspension polymerization method, the charge control agent can have small polymerization inhibition effects and can be substantially free of substances soluble in aqueous media.

A material for controlling the toner to be negatively charged may be a monoazo metal compound; an acetylacetone metal compound; an aromatic oxycarboxylic acid; an aromatic dicarboxylic acid; an oxycarboxylic acid or dicarboxylic acid metal compound; an aromatic mono or polycarboxylic acids or a metal salt, an anhydride, or an ester thereof; a phenol derivative, such as bisphenol; a urea derivative; a metal-containing salicylic acid compound; a metal-containing naphthoic acid compound; a boron compound; a quaternary ammonium salt; a calixarene; or a charge control resin.

The charge control resin may be a polymer or copolymer with a sulfonic acid group, a sulfonic acid salt group, or a sulfonic ester group. The polymer with a sulfonic acid group, a sulfonic acid salt group, or a sulfonic ester group is particularly preferably a polymer containing an acrylamide monomer with a sulfonic acid group or a methacrylamide monomer with a sulfonic acid group in a copolymerization ratio of 2% by mass or more, more preferably 5% by mass or more.

The charge control resin preferably has a glass transition temperature (Tg) of 35° C. or more and 90° C. or less, a peak molecular weight (Mp) of 10,000 or more and 30,000 or less, and a weight-average molecular weight (Mw) of 25,000 or more and 50,000 or less. This can impart preferable triboelectric charging characteristics without affecting the thermal properties required for the toner particles. Furthermore, the charge control resin with a sulfonic acid group can improve, for example, the dispersibility of the charge control resin itself or the dispersibility of a colorant or the like in the polymerizable monomer composition, and further improve the tinting strength, transparency, and triboelectric charging characteristics.

These charge control agents or charge control resins may be added alone or in combination. The amount of the charge control agent or the charge control resin to be added is preferably 0.01 parts by mass or more and 20.0 parts by mass or less, more preferably 0.5 parts by mass or more and 10.0 parts by mass or less, per 100.0 parts by mass of the binder resin.

### <External Additive>

The toner can be produced by externally adding the hydrophobized fine alumina particles and, if necessary, fine inorganic particles other than the hydrophobized fine alumina particles as an external additive to the toner particles. The fine inorganic particles may be fine silica particles, fine strontium titanate particles, fine particles of a hydrotalcite compound, fine particles of a fatty acid metal salt, or fine metal oxide particles, such as fine titania particles, fine zinc oxide particles, fine cerium oxide particles, or fine calcium carbonate particles.

Another external additive may be fine composite oxide particles containing two or more metals, or two or more types arbitrarily selected from the fine particle group.

It is also possible to use fine resin particles or fine organic-inorganic composite particles of fine resin particles and fine inorganic particles. In addition to fine silica particles, the toner can contain titania particles with the following shapes (i) and (ii) as another external additive.
(i) A long diameter of 300 nm or more and 3000 nm or less, and
(ii) an aspect ratio of 5.0 or more.

The titania particles satisfying (i) and (ii) have a large particle size and are spicule as an external additive. The titania particles serve as a spacer, can prevent the hydrophobized fine alumina particles from being embedded in and detached from the toner particles, and can maintain stable transferability for extended periods.

Another external additive may be subjected to hydrophobic treatment with a hydrophobic treatment agent. As in the hydrophobized fine alumina particles, the hydrophobic treatment agent may be a chlorosilane, an alkoxysilane, a silazane, silicone oil, a siloxane, a fatty acid, or a metal salt thereof. Among these, an alkoxysilane, a silazane, and silicone oil facilitate hydrophobic treatment. These hydrophobic treatment agents may be used alone or in combination.

The external additive content is 0.05 parts by mass or more and 20.0 parts by mass or less per 100 parts by mass of the toner particles. The external additive content other than the hydrophobized fine alumina particles is preferably 0.1 parts by mass or more and 2.0 parts by mass or less, more preferably 0.5 parts by mass or more and 1.5 parts by mass or less, per 100 parts by mass of toner particles.

### <Method for Producing Toner>

The toner can be produced by any method, including a known method, such as a pulverization method, a suspension polymerization method, a dissolution suspension method, an emulsion aggregation method, or a dispersion polymerization method. In such a method for producing toner particles, the toner particles can be produced by adding a boric acid source when mixing raw materials. The toner can be produced by the following method. More specifically, the toner can be produced by the emulsion aggregation method.

A method for producing toner includes the following steps (1) to (3), and a boric acid source is added to a dispersion liquid in the step (2) or (3).
(1) A dispersion step of preparing a dispersion liquid of fine binder resin particles containing a binder resin;
(2) an aggregation step of aggregating fine binder resin particles contained in the dispersion liquid of the fine binder resin particles to form an aggregate; and
(3) a fusion step of fusing the aggregate by heating.

When the toner is produced by the emulsion aggregation method, the shape of the toner is easily controlled, and boric acid is easily and uniformly dispersed near the toner particle surface. The emulsion aggregation method is described in detail below.

### <Emulsion Aggregation Method>

The emulsion aggregation method is a method for producing toner particles by preparing in advance an aqueous dispersion liquid of fine particles with a sufficiently smaller diameter than a target diameter composed of a constituent material of the toner particles, aggregating the fine particles in an aqueous medium to the particle diameter of the toner particles, and fusing the resin by heating or the like.

Thus, in the emulsion aggregation method, toner particles are produced through the dispersion step of preparing a fine particle dispersion liquid composed of a constituent material of the toner particles, the aggregation step of aggregating fine particles composed of the constituent material of the toner particles and controlling the particle diameter to the particle diameter of the toner particles, the fusion step of fusing the resin contained in the resulting agglomerate, a spheroidizing step of melting by heating or the like to control the toner surface profile, a subsequent cooling step, a metal removal step of filtering off the resulting toner and removing excessive polyvalent metal ions, a filtration and cleaning step of cleaning with deionized water or the like, and a step of removing moisture from the cleaned toner particles and drying the toner particles.

### [Step of Preparing Dispersion Liquid of Fine Resin Particles (Dispersion Step)]

A dispersion liquid of fine resin particles can be prepared by a known method or another method. The known method is, for example, an emulsion polymerization method, a self-emulsification method, a phase-inversion emulsification method of adding an aqueous medium to a solution of a resin dissolved in an organic solvent to emulsify the resin, or a forced emulsification method of forcibly emulsifying a resin by a treatment in an aqueous medium at a high temperature without using an organic solvent.

More specifically, a binder resin is dissolved in an organic solvent capable of dissolving the binder resin, and a surfactant or a basic compound is added thereto. When the binder resin is a crystalline resin with a melting point, the binder resin may be melted by heating to the melting point or higher. Subsequently, while stirring with a homogenizer or the like, an aqueous medium is slowly added to precipitate the fine resin particles. Subsequently, the solvent is removed by heating or reducing the pressure to prepare an aqueous dispersion liquid of the fine resin particles. The organic solvent used to dissolve the resin may be any organic solvent that can dissolve the resin, and may be an organic solvent, such as toluene, that forms a homogeneous phase with water from the perspective of reducing the occurrence of a coarse powder.

A surfactant used for the emulsification is, for example, but not limited to, an anionic surfactant, such as a sulfate, a sulfonate, a carboxylate, a phosphate, or a soap; a cationic surfactant, such as an amine salt or a quaternary ammonium salt; or a nonionic surfactant, such as poly(ethylene glycol), an alkylphenol ethylene oxide adduct, or a polyhydric alcohol. The surfactants may be used alone or in combination.

A basic compound used in the dispersion step may be an inorganic base, such as sodium hydroxide or potassium hydroxide; or an organic base, such as ammonia, triethylamine, trimethylamine, dimethylaminoethanol, or diethylaminoethanol. The basic compounds may be used alone or in combination.

The 50% particle diameter (D50) based on the volume distribution of the fine particles of the binder resin in the aqueous dispersion liquid of the fine resin particles is preferably 0.05 μm or more and 1.0 μm or less, more preferably 0.05 μm or more and 0.4 μm or less. Adjusting the 50% particle diameter (D50) based on the volume distribution to these ranges facilitates the production of toner particles with an appropriate volume-average particle diameter of 3 μm or more and 10 μm or less.

The 50% particle diameter (D50) based on the volume distribution is measured with a dynamic light scattering particle size distribution analyzer Nanotrac UPA-EX150 (manufactured by Nikkiso Co., Ltd.).

### [Dispersion Liquid of Fine Colorant Particles]

A dispersion liquid of fine colorant particles to be used if necessary can be prepared by the following known method or another method.

It can be prepared by mixing a colorant, an aqueous medium, and a dispersant using a known mixer, such as a stirrer, an emulsifier, or a disperser. The dispersant used herein may be a known dispersant, such as a surfactant or a polymer dispersant.

Although the surfactant and the polymer dispersant can be removed in the cleaning step described later, the surfactant can be used from the perspective of cleaning efficiency.

The surfactant may be an anionic surfactant, such as a sulfate, a sulfonate, a phosphate, or a soap; a cationic surfactant, such as an amine salt or a quaternary ammonium salt; or a nonionic surfactant, such as poly(ethylene glycol), an alkylphenol ethylene oxide adduct, or a polyhydric alcohol.

In particular, a nonionic surfactant or an anionic surfactant can be used. Furthermore, a nonionic surfactant and an anionic surfactant may be used in combination. The surfactants may be used alone or in combination. The concentration of the surfactant in the aqueous medium is preferably 0.5% by mass or more and 5% by mass or less.

The fine colorant particle content of the dispersion liquid of fine colorant particles is preferably, but not limited to, 1% by mass or more and 30% by mass or less of the total mass of the dispersion liquid of fine colorant particles.

With respect to the dispersed particle size of the fine colorant particles in the aqueous dispersion liquid of the colorant, the 50% particle diameter (D50) based on the volume distribution is preferably 0.5 μm or less from the perspective of the dispersibility of the colorant in the finally produced toner. For the same reason, the 90% particle diameter (D90) based on the volume distribution is preferably 2 μm or less. The dispersed particle size of the fine colorant particles dispersed in the aqueous medium is measured with a dynamic light scattering particle size distribution analyzer (Nanotrac UPA-EX150 manufactured by Nikkiso Co., Ltd.).

A known mixer, such as a stirrer, an emulsifier, or a disperser, to be used to disperse the colorant in the aqueous medium may be an ultrasonic homogenizer, a jet mill, a pressure homogenizer, a colloid mill, a ball mill, a sand mill, or a paint shaker. These may be used alone or in combination.

### [Dispersion Liquid of Fine Release Agent (Aliphatic Hydrocarbon Compound) Particles]

If necessary, a dispersion liquid of fine release agent particles may be used. A dispersion liquid of fine release agent particles can be prepared by the following known method or another method.

The dispersion liquid of fine release agent particles can be prepared by adding a release agent to an aqueous medium containing a surfactant, heating the release agent to a temperature above the melting point of the release agent, dispersing the release agent in the form of particles using a homogenizer with a strong shearing ability (for example, “Clearmix W-Motion” manufactured by M Technique Co., Ltd.) or a pressure discharge type disperser (for example, “Gaulin homogenizer” manufactured by Gaulin), and cooling the dispersion liquid to a temperature below the melting point.

With respect to the dispersed particle size of the dispersion liquid of fine release agent particles in the aqueous dispersion liquid of the release agent, the 50% particle diameter (D50) based on the volume distribution is preferably 0.03 μm or more and 1.0 μm or less, more preferably 0.1 μm or more and 0.5 pan or less. Furthermore, no coarse particles of 1 μm or more may be present.

When the dispersed particle size of the dispersion liquid of fine release agent particles is in the above range, the release agent can be finely dispersed in the toner, the bleeding effect at the time of fixing can be maximized, and good separability can be achieved. The dispersed particle size of the dispersion liquid of fine release agent particles dispersed in the aqueous medium can be measured with a dynamic light scattering particle size distribution analyzer (Nanotrac UPA-EX150 manufactured by Nikkiso Co., Ltd.).

### [Mixing Step]

In the mixing step, a liquid mixture is prepared by mixing the dispersion liquid of fine resin particles and, if necessary, at least one of the dispersion liquid of fine release agent particles and the dispersion liquid of fine colorant particles. A known mixing apparatus, such as a homogenizer or a mixer, may be used.

### [Step of Forming Aggregate Particles (Aggregation Step)]

In the aggregation step, fine particles contained in the liquid mixture prepared in the mixing step are aggregated to form an aggregate with a target particle size. At this time, an aggregating agent is added and mixed, and at least one of heating and mechanical power is appropriately applied as required to form an aggregate in which fine resin particles and, if necessary, at least one of fine release agent particles and fine colorant particles are aggregated.

The aggregating agent is, for example, an organic aggregating agent, such as a cationic surfactant of a quaternary salt or a poly(ethylene imine); an inorganic metal salt, such as sodium sulfate, sodium nitrate, aluminum chloride, sodium chloride, calcium chloride, or calcium nitrate; an inorganic metal salt polymer, such as polyaluminum chloride, polyaluminum hydroxide, or polyferric sulfate; an inorganic ammonium salt, such as ammonium sulfate, ammonium chloride, or ammonium nitrate; or an inorganic aggregating agent, such as a divalent or polyvalent metal complex. It is also possible to add an acid, such as sulfuric acid or nitric acid, to lower the pH and cause soft aggregation. These may be used alone or in combination. An aggregating agent containing aluminum can be used to control the aluminum content of the toner particles by the type and the addition amount of the aggregating agent.

The aggregating agent may be added in the form of a dry powder or an aqueous solution of the aggregating agent dissolved in an aqueous medium, and may be added in the form of an aqueous solution to cause uniform aggregation. The aggregating agent can be added and mixed at a temperature below the glass transition temperature or the melting point of the resin contained in the liquid mixture. Mixing under this temperature condition promotes relatively uniform aggregation. The aggregating agent can be mixed into the liquid mixture by using a known mixing apparatus, such as a homogenizer or a mixer. The aggregation step is the step of forming an aggregate with the toner particle size in an aqueous medium. The aggregate produced in the aggregation step preferably has a volume-average particle diameter of 3 μm or more and 10 μm or less. The volume-average particle diameter can be measured by a Coulter method using a particle size distribution analyzer (Coulter Multisizer III manufactured by Coulter).

### <Step of Producing Dispersion Liquid Containing Toner Particles (Fusion Step)>

In the fusion step, in the dispersion liquid containing the aggregate produced in the aggregation step, the aggregation is first stopped while stirring as in the aggregation step. The aggregation is stopped by adding an aggregation terminator, such as a base with an adjustable pH, a chelate compound, or an inorganic salt compound, such as sodium chloride.

After the dispersion state of the agglomerate in the dispersion liquid becomes stable by the action of the aggregation terminator, the dispersion liquid is heated to a temperature above the glass transition temperature or the melting point of the binder resin to fuse the agglomerate and adjust the particle diameter to a desired particle diameter. The toner particles preferably have a weight-average particle diameter (D4) of 3 μm or more and 10 μm or less.

### [Cooling Step]

If necessary, in the cooling step, the temperature of the dispersion liquid containing the toner particles produced in the fusion step may be lowered to a temperature below at least one of the crystallization temperature and the glass transition temperature of the binder resin.

### [Post-Treatment Steps]

In the method for producing toner, the cooling step may be followed by post-treatment steps, such as a cleaning step, a solid-liquid separation step, and/or a drying step, and dried toner particles are produced by the post-treatment steps.

### [External Addition Step]

In an external addition step, hydrophobized fine alumina particles are externally added to the toner particles produced in the drying step. In addition to the hydrophobized fine alumina particles, another external additive as described above may be added if necessary. External additives can be added, for example, in the dry state under shear force.

After the toner particles (core particles) are produced by any of the methods described above, the method for producing the toner particles can include a shell-forming step of further adding fine resin particles containing a resin for a shell, which are to be adhered to the core particles and form a shell, to an aqueous medium containing dispersed core particles. After the agglomerate (core particles) is produced in the aggregation step, the method for producing toner by the emulsion aggregation method can include a shell-forming step of further adding fine resin particles containing a resin for a shell to be adhered to the core particles and form a shell. Thus, the toner particles can have a core particle containing a binder resin and a shell on the surface of the core particle. The resin for the shell may be the same resin as the binder resin or another resin. The amount of the resin for the shell to be added is preferably 1 part by mass or more and 10 parts by mass or less, more preferably 2 parts by mass or more and 7 parts by mass or less, per 100 parts by mass of the binder resin contained in the core particles.

In this case, the method for producing toner can include the following steps.
(1) A dispersion step of preparing a dispersion liquid of fine binder resin particles containing a binder resin;
(2-1) an aggregation step of aggregating fine binder resin particles contained in the dispersion liquid of the fine binder resin particles to form an aggregate;
(2-2) a shell-forming step of further adding fine resin particles containing a resin for a shell, which are to be adhered to the aggregate and form the aggregate with a shell, to the dispersion liquid containing the aggregate; and
(3) a fusion step of heating and fusing the aggregate with the shell.

To facilitate the inclusion of boric acid in the vicinity of the toner particle surface, a boric acid source, together with the fine resin particles containing the resin for the shell, can be added to the dispersion liquid containing the aggregate in the step (2-2).

The boric acid source may be boric acid or a compound that can be converted into boric acid by pH control or the like during toner production. For example, at least one selected from the group consisting of boric acid, borax, organic boric acids, borate salts, borate esters, and the like may be used. For example, the boric acid source may be added such that boric acid is contained in the aggregate. The pH is controlled to an acidic condition in the aggregation step (2-1), and the shell-forming step is performed.

Boric acid may be present in an unsubstituted state in the aggregate. The boric acid source can be at least one selected from the group consisting of boric acid and borax. When the toner is produced in an aqueous medium, a borate salt can be added from the perspective of reactivity and production stability. More specifically, the boric acid source can contain at least one selected from the group consisting of sodium tetraborate, borax, and ammonium borate, particularly borax.

Borax is a decahydrate of sodium tetraborate Na₂B₄O₇, which is converted into boric acid in an acidic aqueous solution, and borax may therefore be used in an aqueous medium in an acidic environment. Borax may be added in the form of a dry powder or an aqueous solution of borax dissolved in an aqueous medium, and may be added in the form of an aqueous solution to cause uniform aggregation. The concentration in the aqueous solution may be appropriately changed with the concentration in the toner and is, for example, 1% to 20% by mass. For conversion to boric acid, the pH can be adjusted to an acidic condition before, during, or after the addition. For example, it may be controlled to be 1.5 or more and 5.0 or less, preferably 2.0 or more and 4.0 or less. The pH can be controlled before the aggregation step to form an aggregate.

More specifically, the pH can be controlled to an acidic condition in the mixing step of mixing the dispersion liquid of the fine binder resin particles and, if necessary, another dispersion liquid, such as the dispersion liquid of fine release agent particles, before the aggregation step.

### [Methods for Measuring Physical Properties]

Next, methods for measuring physical properties are described.

### <Identification and Quantitative Determination of Boric Acid in Toner Particles>

The identification and quantitative determination of boric acid in the toner particles are performed by the following methods.

### (ATR-IR Analysis Using Germanium (Ge) as ATR Crystal)

Whether or not the toner particles contain boric acid can be determined using an infrared absorption spectrum. More specifically, toner particles produced by removing external additives from toner by the method described below are used for the measurement by an ATR method using germanium (Ge) as an ATR crystal.

IR analysis is performed by the ATR method using a Fourier transform infrared spectrometer (Spectrum One manufactured by PerkinElmer, Inc.) equipped with a universal ATR sampling accessory. The specific measurement procedure is described below.

The incident angle of infrared light (λ=5 μm) is 45 degrees. A Ge ATR crystal (refractive index=4.0) is used as an ATR crystal. Other conditions are as follows:
Range
Start: 4000 cm⁻¹
End: 650 cm⁻¹ (Ge ATR crystal)
Duration
Scan number: 16
Resolution: 4.00 cm⁻¹
Advanced: with CO₂/H₂O correction
(1) Mount the Ge ATR crystal (refractive index=4.0) on the apparatus.
(2) Set Scan type to Background and Units to EGY to measure the background.
(3) Set Scan type to Sample and Units to A.
(4) Accurately weigh 0.01 g of toner particles on the ATR crystal.
(5) Pressurize the sample with a pressure arm. (Force Gauge is 90)
(6) Measure the sample.

A 1380 cm⁻¹ peak corresponding to a B—O single bond in an absorption spectrum is checked. The detection of an absorption peak at 1380 cm⁻¹ is judged to be the detection of boric acid.

(Method for Calculating Ratio I_{B}/I_{C} of Peak Is Derived from Boric Acid to Peak I_{C} Derived from Carbonyl Group)

In the ATR-IR analysis of the toner particles, the intensity ratio I_{B}/I_{C} is determined, wherein In denotes the peak intensity of an absorption peak at 1380 cm⁻¹ derived from boric acid, and I_{C} denotes the peak intensity at 1750 to 1700 cm⁻¹ derived from a carbonyl group of a binder resin component contained in the toner particles.

### <X-Ray Fluorescence Measurement of Toner Particles>

The boric acid content and the aluminum content of the toner particles are measured by fluorescent X-rays and are determined by a calibration curve method. The fluorescent X-rays of boron and aluminum are measured in accordance with JIS K 0119-1969, as specifically described below.

The measuring apparatus is a wavelength-dispersive X-ray fluorescence analyzer “Axios” (manufactured by PANalytical) and attached dedicated software “Super(ver. 4.0F” (manufactured by PANalytical) for specifying measurement conditions and analyzing measured data. Rh is used as an anode of an X-ray tube, the measurement atmosphere is vacuum, the measurement diameter (collimator mask diameter) is 27 mm, and the measurement time is 10 seconds. Boron is detected with a proportional counter (PC), and aluminum is detected with a scintillation counter (SC).

As a measurement sample, 4 g of toner particles are put into a special-purpose aluminum ring for press, are flattened, and are pressurized at 20 MPa for 60 seconds using a tablet molding machine “BRE-32” (manufactured by Maekawa Testing Machine Mfg. Co., Ltd.), thus forming pellets with a thickness of approximately 2 mm and a diameter of approximately 39 mm. Using the pellets, the counting rate (unit: cps) of B-Kα radiation observed at a diffraction angle (20) of 41.75 degrees is measured using PET as an analyzing crystal.

The accelerating voltage and the current value of an X-ray generator are 32 kV and 125 mA, respectively.

Boron and aluminum are measured under the conditions described above, and the counting rate (unit: kops), which is the number of X-ray photons per unit time, is measured.

The boric acid content (% by mass) of the toner particles is determined from a separately prepared calibration curve of boric acid. Toner particles produced by removing external additives from toner by the following method may also be used for the measurement.

<Method for Separating and Recovering Toner Particles and Hydrophobized Fine Alumina Particles from Toner>

160 g of sucrose (manufactured by Kishida Chemical Co., Ltd.) is dissolved in 100 mL of deionized water in a vessel in hot water to prepare a concentrated sucrose solution. A centrifugation tube (volume: 50 ml) is charged with 31 g of the concentrated sucrose solution and 6 mL of Contaminon N (a 10% by mass aqueous neutral detergent for cleaning precision measuring instruments composed of a nonionic surfactant, an anionic surfactant, and an organic builder, pH 7, manufactured by Wako Pure Chemical Industries, Ltd.). 1.0 g of toner is added to the centrifugation tube, and agglomerates of toner are triturated with a spatula. The centrifugation tube is shaken in a shaker (AS-IN sold by As One Corporation) at 300 strokes per minute (spm) for 20 minutes. After shaking, the solution is transferred to a glass tube for a swing rotor (50 mL) and is centrifuged in a centrifugal separator (H-9R manufactured by Kokusan Co., Ltd.) at 3500 rpm for 30 minutes.

Toner particles are separated from an external additive by this operation. Sufficient separation of the toner particles from the aqueous solution is visually inspected, and the toner particles and the external additive thus separated are collected with a spatula. When fine inorganic particles A and another external additive are mixed as external additives, they are further isolated by centrifugation utilizing the difference in particle size and specific gravity to obtain a target product. This operation is performed multiple times to prepare a required amount. The collected toner particles and hydrophobized fine alumina particles are filtered through a vacuum filter and are dried in a dryer for 1 hour or more to prepare a measurement sample. This operation is performed multiple times to prepare a required amount.

### <Method for Measuring Hydrophobized Fine Alumina Particle Content of Toner>

The hydrophobized fine alumina particle content of the toner can be calculated from X-ray fluorescence analysis (XRF) of the toner and the toner particles from which the external additive is removed by the method described above.

The measuring apparatus is a wavelength-dispersive X-ray fluorescence analyzer “Axios” (manufactured by PANalytical) and attached dedicated software “SuperQ ver. 4.0F” (manufactured by PANalytical) for specifying measurement conditions and analyzing measured data. Rh is used as an anode of an X-ray tube, the measurement atmosphere is vacuum, the measurement diameter (collimator mask diameter) is 27 mm, and the measurement time is 10 seconds. Boron, a light element, is detected with a proportional counter (PC).

As a measurement sample, 4 g of toner is put into a special-purpose aluminum ring for press, is flattened, and is pressurized at 20 MPa for 60 seconds using a tablet molding machine “BRE-32” (manufactured by Maekawa Testing Machine Mfg. Co., Ltd.), thus forming pellets with a thickness of approximately 2 mm and a diameter of approximately 39 mm. Using the pellets, the counting rate intensity (unit: cps) of the group 13 element is measured.

The accelerating voltage and the current value of an X-ray generator are 32 kV and 125 mA, respectively.

<Method for Measuring Fragment lons by Time-of-Flight Secondary lon Mass Spectrometry (TOF-SIMS) for Identification of Hydrophobic Treatment Agent for Hydrophobized Fine Alumina Particles>

TOF-SIMS measurement of the hydrophobized fine alumina particles is performed using the hydrophobized fine alumina particles separated from the toner by the method for separating the hydrophobized fine alumina particles from the toner surface.

For the measurement of fragment ions on the surface of fine silica particles using TOF-SIMS, TRIFT-IV manufactured by ULVAC-PHI, Inc. is used.

The analytical conditions are as follows:
Sample preparation: Hydrophobized fine alumina particles are adhered to an indium sheet.
Primary ion: Au ion
Accelerating voltage: 30 kV
Charge neutralization mode: On
Measurement mode: Positive
Raster: 200 μm
Measurement time: 60 s

From the resulting mass profile of secondary ion mass/secondary ion charge number (m/z), the hydrophobic treatment agent for the hydrophobized fine alumina particles is identified. For example, when the hydrophobic treatment agent is dimethyl silicone oil, fragment ions are observed at positions of m/z=147, 207, and 221.

### <Method for Measuring Number-Average Particle Diameter of Hydrophobized Fine Alumina Particles>

The number-average particle diameter of the hydrophobized fine alumina particles is measured with a scanning electron microscope “Ultra Plus” (trade name; manufactured by Zeiss). The hydrophobized fine alumina particles are identified by the SEM-EDS analysis.

The toner is observed under the following conditions, the longest diameter of the primary particles of 100 particles of the hydrophobized fine alumina particles is measured, and the average value thereof is defined as the number-average particle diameter of the hydrophobized fine alumina particles. The observation magnification is appropriately adjusted for the size of the hydrophobized fine alumina particles.

### (SEM Observation Conditions)

Sample pretreatment: Pt coating after fixing toner with a carbon tape
SEM accelerating voltage: 2.0 kV
WD: 2.8 mm
Detector: SE2
Resolution: 1024×768 pixels
Observation magnification: 5,000 to 50,000 times

### <Method for Measuring Hydrophobicity of Hydrophobized Fine Alumina Particles>

The hydrophobicity (% by volume) of an external additive is measured with a powder wettability tester “WET-100P” (manufactured by Rhesca Corporation). A fluoropolymer-coated spindle rotor with a length of 25 mm and a maximum body diameter of 8 mm is placed in a cylindrical glass vessel with a diameter of 5 cm and a thickness of 1.75 mm. 70 mL of hydrous methanol composed of 50% by volume of methanol and 50% by volume of water is introduced into the cylindrical glass vessel. Subsequently, 0.5 g of hydrophobized fine alumina particles are added thereto and are placed in the powder wettability tester. Methanol is added to the liquid at 0.8 mL/min in the powder wettability tester while stirring with a magnetic stirrer at 200 rpm. The transmittance is measured using light with a wavelength of 780 nm, and the value expressed by the volume percentage of methanol (=(volume of methanol/volume of mixture)×100) when the transmittance reaches 50% is defined as hydrophobicity. Depending on the hydrophobicity of the sample, the initial volume ratio of methanol to water is adjusted appropriately.

### <Method for Measuring Volume Resistivity of Hydrophobized Fine Alumina Particles>

The volume resistivity of the hydrophobized fine alumina particles was calculated from the current value measured with an electrometer (6430 Sub-Femtoamp Remote Source Meter manufactured by Keithley Instruments, Inc.). 2.0 g of an external additive in a sample holder (SH2-Z manufactured by Toyo Corporation) is compressed by applying a torque of 2.0 N·m. A voltage of 10.0 V was applied to the external additive through the sample holder, the current value at saturation not including the charge current was measured, and the volume resistivity of the hydrophobized fine alumina particles was calculated from the distance between sample holder electrodes and the areas of the electrodes.

<Rate of atoms originated from Fine Base Particles in Hydrophobized Fine Alumina Particles>

The rate of atoms originated from the fine base particles of the hydrophobized fine alumina particles is calculated by analyzing the surface composition by electron spectroscopy for chemical analysis (ESCA) using the hydrophobized fine alumina particles separated from the toner by the method for separating the hydrophobized fine alumina particles from the toner surface.
Apparatus: Quantum 2000 manufactured by ULVAC-PHI, Inc.
Measurement conditions for X-ray photoelectron spectrometer: X-ray source Al Kα
X-rays: 100 μm 25 W 15 kV
Raster: 300 μm×200 μm
Pass energy: 58.70 eV
Step size: 0.125 eV
Neutralizing electron gun: 20 μA, 1 V
Ar ion gun: 7 mA, 10 V

The surface atomic concentration (atomic %) is calculated from the measured peak intensity of each atom using a relative sensitivity factor provided by PHI. Furthermore, a peak (binding energy: 73.9 eV) of an aluminum atom derived from fine alumina particles as fine base particles is separated from a peak of an aluminum atom to calculate the aluminum atomic concentration (atomic %) derived from fine alumina particles on the surface. Because alumina (Al₂O₃) is composed of two aluminum atoms and three oxygen atoms, the total atomic concentration (atomic %) derived from alumina becomes 2.5 times of the aluminum atomic concentration. The total atomic concentration (atomic %) was used as the rate of atoms originated from the fine base particles.

### <Method for Measuring Carbon Content of Hydrophobized Fine Alumina Particles>

The carbon content of the hydrophobized fine alumina particles derived from a hydrophobic treatment agent is measured with a carbon-sulfur analyzer (trade name: EMIA-320) manufactured by Horiba, Ltd. 0.3 g of the sample bydrophobized fine alumina particles is accurately weighed in a crucible for the carbon-sulfur analyzer. 0.3±0.05 g of tin (option No. 9052012500) and 1.5±0.1 g of tungsten (option No. 9051104100) are added as combustion accelerators. The hydrophobized fine alumina particles are then heated at 1100° C. in an oxygen atmosphere in accordance with an instruction manual of the carbon-sulfur analyzer. Hydrophobic groups on the surface of the hydrophobized fine alumina particles derived from the hydrophobic treatment agent are thermally decomposed into CO₂, and the amount of CO₂ is measured. The carbon content (% by mass) of the hydrophobized fine alumina particles is determined from the amount of CO₂ and is considered to be the carbon content derived from a hydrophobic treatment agent.

<Method for Calculating Value by Dividing Mass Change Rate of Hydrophobized Fine Alumina Particles with Respect to Relative Humidity by Specific Surface Area>

As a measure of the water content of the hydrophobized fine alumina particles, a value (mass change rate/specific surface area) is calculated by dividing the mass change rate of the hydrophobized fine alumina particles by the specific surface area of the hydrophobized fine alumina particles when the hydrophobized fine alumina particles are left for 24 hours in an environment of a temperature of 30° C. and a relative humidity of 0% and are then left for 1 hour in an environment of a temperature of 30° C. and a relative humidity of 80%.

### (Mass Change Rate)

The mass change rate of the hydrophobized fine alumina particles is measured with a calorimeter “Q5000SA” (manufactured by TA Instruments). Approximately 20 mg of hydrophobized fine alumina particles are placed on a sample pan. The chamber is maintained at a temperature of 30° C. and a relative humidity of 0% for 24 hours and is then programmed to maintain an environment of a temperature of 30° C. and a relative humidity of 80% for 1 hour. The measurement is then started. The mass change rate (%) is expressed by ((TGA2−TGA1)/TGA1)×100, wherein TGA1 denotes the mass after 24 hours from the start, and TGA2 denotes the mass after 1 hour in the environment of a temperature of 30° C. and a relative humidity of 80%.

### (Specific Surface Area)

The specific surface area of hydrophobized fine alumina particles was measured by a BET method based on nitrogen adsorption according to JIS Z 8830 (2001). The measuring apparatus is an automatic specific surface area and porosimetry analyzer “TriStar 3000” (manufactured by Shimadzu Corporation), which employs a constant-volume gas adsorption method as a measurement method. Setting of measurement conditions and analysis of measured data are performed using dedicated software “TriStar 3000 Version 4.00” attached to the apparatus. The apparatus is coupled to a vacuum pump, nitrogen gas piping, and helium gas piping. A value calculated by a BET multipoint method using nitrogen gas as an adsorption gas is defined as a BET specific surface area in the present disclosure.

The BET specific surface area is calculated as described below. First, nitrogen gas is adsorbed on hydrophobized fine alumina particles to measure the equilibrium pressure P (Pa) in the sample cell and the nitrogen adsorption amount Va (mol·g⁻¹) of the hydrophobized fine alumina particles. An adsorption isotherm is obtained in which the horizontal axis represents the relative pressure Pr calculated by dividing the equilibrium pressure P (Pa) in the sample cell by the saturated vapor pressure Po (Pa) of nitrogen, and the vertical axis represents the nitrogen adsorption amount Va (mol·g⁻¹). Next, the monolayer amount Vm (mol·g⁻¹), which is the amount of adsorption necessary to form a monolayer on the surface of the hydrophobized fine alumina particles, is determined using the following BET equation.

$$Slope of straight line = ( C - 1 ) / ( Vm \times C )$$

$$Intercept of straight line = 1 / ( Vm \times C )$$

C denotes a BET parameter and is a variable that varies with the type of measurement sample, the type of adsorption gas, and the adsorption temperature.

The BET equation can be interpreted as a straight line with a slope of (C−1)/(Vm×C) and an intercept of 1/(Vm×C), where Pr is the X-axis and Pr/Va(1−Pr) is the Y-axis (this straight line is referred to as a BET plot).

$$Pr / Va ( 1 - Pr ) = 1 / ( Vm \times C ) + ( C - 1 ) \times Pr / ( Vm \times C )$$

By plotting the measured values of Pr and Pr/Va(1−Pr) on a graph and drawing a straight line by the least squares method, the slope and intercept values of the straight line can be calculated. Simultaneous equations of the slope and the intercept can be solved using these values to calculate Vm and C.

Furthermore, the BET specific surface area S (m²·g⁻¹) of the hydrophobized fine alumina particles is calculated using the following equation from the calculated Vm and the molecular cross-sectional area (0.162 nm²) of the nitrogen molecule. S=Vm×N×0.162×10⁻¹⁸ (N denotes Avogadro's number (mol⁻¹).)

The measurement using the apparatus is performed in accordance with “TriStar 3000 Instruction Manual V. 4.0” attached to the apparatus and is more specifically performed by the following procedure.
(1) A well-washed and dried special-purpose glass sample cell (stem diameter: ⅜ inch, volume: approximately 5 ml) is accurately tared. Approximately 1.5 g of hydrophobized fine alumina particles are then put into the sample cell using a funnel. The sample cell containing the hydrophobized fine alumina particles is placed in a pretreatment apparatus “Vacuprep 061” (manufactured by Shimadzu Corporation) coupled to a vacuum pump and nitrogen gas piping and is subjected to vacuum degassing at 23° C. for approximately 10 hours. The vacuum degassing is gradually performed by adjusting the valve so that the hydrophobized fine alumina particles are not sucked into the vacuum pump. The pressure in the cell gradually decreases with degassing and finally reaches approximately 0.4 Pa (approximately 3 mmTorr). After completion of vacuum degassing, nitrogen gas is gradually injected to return the sample cell to atmospheric pressure, and the sample cell is removed from the pretreatment apparatus. The mass of the sample cell is then accurately measured, and the accurate mass of the hydrophobized fine alumina particles is calculated from the difference from the tare. The sample cell is covered with a rubber stopper during weighing to prevent the hydrophobized fine alumina particles in the sample cell from being contaminated with atmospheric water or the like.
(2) Next, a special-purpose “isothermal jacket” is attached to a stem portion of the sample cell containing the hydrophobized fine alumina particles. A special-purpose filler rod is inserted into the sample cell, and the sample cell is placed in an analysis port of the apparatus. The isothermal jacket is a tubular member that can suck up liquid nitrogen to a certain level by capillarity and has an inner surface made of a porous material and an outer surface made of an impermeable material.
(3) Subsequently, the free space of the sample cell including a connection apparatus is measured. The free space is calculated by measuring the volume of the sample cell using helium gas at 23° C., measuring the volume of the sample cell using helium gas in the same manner after cooling the sample cell with liquid nitrogen, and converting the difference between these volumes. The saturated vapor pressure Po (Pa) of nitrogen is automatically measured separately using a Po tube built into the apparatus.
(4) Next, after the sample cell is subjected to vacuum degassing, the sample cell is cooled with liquid nitrogen while the vacuum degassing is continued. Subsequently, nitrogen gas is introduced stepwise into the sample cell to adsorb nitrogen molecules on the hydrophobized fine alumina particles. The adsorption isotherm can be obtained by measuring the equilibrium pressure P (Pa) as needed and is converted into a BET plot. The points of the relative pressure Pr for collecting data are a total of 6 points of 0.05, 0.10, 0.15, 0.20, 0.25, and 0.30.
(5) A straight line is drawn from the measured data by the least squares method, and Vm is calculated from the slope and the intercept of the straight line. Furthermore, the BET specific surface area of the hydrophobized fine alumina particles is calculated from the value of Vm, as described above.

### <Method for Measuring Weight-Average Particle Diameter (D4) of Toner or Toner Particles>

A toner or toner particles are subjected to measurement with a precision particle size distribution analyzer “Coulter Counter Multisizer 3” (registered trademark, manufactured by Beckman Coulter, Inc.) using an aperture impedance method and using associated dedicated software “Beckman Coulter Multisizer 3 Version 3.51” (available from Beckman Coulter, Inc.) for specifying measurement conditions and analyzing measured data. The precision particle size distribution analyzer is equipped with a 100 pun aperture tube. The number of effective measuring channels is 25,000. The weight-average particle diameter (D4) of the toner or toner particles is calculated by analyzing the measured data.

An aqueous electrolyte used in the measurement may be approximately 1% by mass special grade sodium chloride dissolved in deionized water, for example, “ISOTON II” (manufactured by Beckman Coulter, Inc.).

Before the measurement and analysis, the dedicated software is set up as described below.

On the “Standard operation mode (SOM) setting screen” of the dedicated software, the total count number in control mode is set at 50,000 particles, the number of measurements is set at 1, and the Kd value is set at a value obtained with “standard particles 10.0 μm” (manufactured by Beckman Coulter, Inc.). A threshold/noise level measurement button is pushed to automatically set the threshold and noise level. The current is set at 1600 μA. The gain is set at 2. ISOTON II is chosen as an electrolyte solution. Flushing of aperture tube after measurement is checked.

On the “Conversion of pulse into particle diameter setting screen” of the dedicated software, the bin interval is set to the logarithmic particle diameter, the particle diameter bin is set to a 256 particle diameter bin, and the particle diameter range is set at 2 μm or more and 60 μm or less.

The specific measurement method is as follows:
(1) A 250-ml round-bottom glass beaker specifically for Multisizer 3 is charged with approximately 200 ml of the aqueous electrolyte and is placed on a sample stand. A stirrer rod is rotated counterclockwise at 24 revolutions per second. Soiling and air bubbles in the aperture tube are removed using the “Aperture tube flushing” function of the dedicated software.
(2) A 100-ml flat-bottom glass beaker is charged with approximately 30 ml of the aqueous electrolyte. To the aqueous electrolyte is added approximately 0.3 ml of a dispersant “Contaminon N” (a 10% by mass aqueous neutral detergent for cleaning precision measuring instruments composed of a nonionic surfactant, an anionic surfactant, and an organic builder, pH 7, manufactured by Wako Pure Chemical Industries, Ltd.) diluted 3-fold by mass with deionized water.
(3) A predetermined amount of deionized water is poured into a water tank of an ultrasonic disperser “Ultrasonic Dispersion System Tetora 150” (manufactured by Nikkaki-Bios Co., Ltd.). The ultrasonic disperser includes two oscillators with an oscillation frequency of 50 kHz and has an electrical output of 120 W. The two oscillators have a phase difference of 180 degrees. Approximately 2 ml of Contaminon N is added to the water tank.
(4) The beaker in (2) is placed in a beaker-holding hole in the ultrasonic disperser, and the ultrasonic disperser is actuated. The vertical position of the beaker is adjusted such that the surface resonance of the aqueous electrolyte in the beaker is highest.
(5) While the aqueous electrolyte in the beaker in (4) is exposed to ultrasonic waves, approximately 10 mg of toner or toner particles are added little by little to the aqueous electrolyte and is dispersed. The ultrasonic dispersion treatment is continued for another 60 seconds. During the ultrasonic dispersion, the water temperature of the water tank is controlled at 10° C. or more and 40° C. or less.
(6) The aqueous electrolyte containing dispersed toner or toner particles prepared in (5) is added dropwise with a pipette into the round-bottom beaker prepared in (1) placed on the sample stand such that the measurement concentration is approximately 5%. Measurement is continued until the number of measured particles reaches 50,000.
(7) The measured data are analyzed using the accessory dedicated software to determine the weight-average particle diameter (D4). The weight-average particle diameter (D4) is the “Average diameter” on an analysis/volume statistics (arithmetic mean) screen in the setting of graph/volume percentage in the dedicated software. The number-average particle diameter is the “Average diameter” on an “Analysis/number statistics (arithmetic mean)” screen in the setting of graph/number percentage in the dedicated software. [Configurations Included in Embodiments of Present Disclosure]

The disclosure of the present embodiment includes the following configurations.

(Configuration 1) A toner containing: a toner particle containing a binder resin; and an external additive, wherein
a peak corresponding to boric acid is detected in ATR-IR analysis of the toner particle using germanium as an ATR crystal in an ATR method,
the external additive contains a hydrophobized fine alumina particle produced by surface-treating a fine alumina particle, which is a fine base particle, with a hydrophobic treatment agent,
the hydrophobized fine alumina particle has a hydrophobicity of 50 or more and 90 or less,
the hydrophobized fine alumina particle has a volume resistivity of 1.0×10⁸ Ω·cm or more and 1.0×10¹² Ω·cm or less, and
a rate of atoms originated from the fine base particle in the hydrophobized fine alumina particle is 30 atomic % or more and 70 atomic % or less.

(Configuration 2) The toner according to Configuration 1, wherein boron derived from the boric acid has an intensity of 0.10 kcps or more and 0.60 kcps or less in X-ray fluorescence measurement of the toner particle.

(Configuration 3) The toner according to Configuration 1 or 2, wherein the hydrophobized fine alumina particle has a number-average particle diameter of 15 nm or more and 300 nm or less.

(Configuration 4) The toner according to any one of Configurations 1 to 3, wherein the hydrophobized fine alumina particle content is 0.1 parts by mass or more and 5.0 parts by mass or less per 100 parts by mass of the toner particles.

(Configuration 5) The toner according to any one of Configurations 1 to 4, wherein the hydrophobic treatment agent for the hydrophobized fine alumina particle is a silicon compound with a hydrocarbon moiety.

(Configuration 6) The toner according to Configuration 5, wherein the hydrophobized fine alumina particle has a carbon content of 0.5% by mass or more and 10.0% by mass or less.

(Configuration 7) The toner according to Configuration 5 or 6, wherein the hydrophobic treatment agent is dimethyl silicone oil.

(Configuration 8) The toner according to Configuration 5 or 6, wherein the hydrophobic treatment agent is at least one selected from the group consisting of silane compounds represented by the following formula (1) and hydrolysates of the silane compounds,

(RO)₃Si(CH₂)ₙCH₃ (1)

wherein R denotes a methyl group or an ethyl group, and n denotes an integer of 5 or more and 11 or less.

(Configuration 9) The toner according to any one of Configurations 1 to 8, wherein when the hydrophobized fine alumina particle is left for 24 hours in an environment of a temperature of 30° C. and a relative humidity of 0% and is then left for 1 hour in an environment of a temperature of 30° C. and a relative humidity of 80%, a value obtained by dividing a mass change rate of the hydrophobized fine alumina particle by a specific surface area of the hydrophobized fine alumina particle (mass change rate/specific surface area) is 0.005% g/m² or more and 0.100% g/m² or less.

(Configuration 10) The toner according to any one of Configurations 1 to 9, wherein a peak I_{B} derived from boric acid and a peak I_{C} derived from a carbonyl group are detected in the ATR-IR analysis of the toner particle, and a ratio I_{B}/I_{C} is 0.02 or more and 0.30 or less.

### EXAMPLES

Although the present disclosure is further described in the following exemplary embodiments and comparative examples, the present disclosure is not limited to these exemplary embodiments. Unless otherwise specified, “part” in the following formulations in the exemplary embodiments is based on mass.

### <Production Example of External Additive A1>

Untreated fine alumina particles (number-average particle diameter of primary particles: 35 nm) produced by a heat-dried gas phase method were heated as a base to 300° C. in a fluidized state by stirring. A reactor was purged with nitrogen gas and was sealed. 10 parts of dimethyl silicone oil (KF-96-50CS manufactured by Shin-Etsu Chemical Co., Ltd.) was sprayed with a spray nozzle as a hydrophobic treatment agent onto 100 parts of untreated fine alumina particles. Coating treatment was then performed by heating and stirring for 1 hour to cause a reaction. Table 1 shows physical properties of an external additive A1.

### <Production Examples of External Additives A2 to A 18 and A20 to A24>

External additives A2 to A18 and A20 to A24 were produced in the same manner as in the production example of the external additive Al except that the number-average primary particle diameter of the external additive base, the type and the number of parts of the hydrophobic treatment agent, and the treatment temperature were changed as shown in Table 1. Table 1 shows physical properties of the external additives A2 to A18 and A20 to A24.

### <Production Example of External Additive A19>

An external additive A19 was produced in the same manner as in the production example of the external additive A1 except that untreated titania fine particles (number-average particle diameter of primary particles: 35 nm) produced by a sulfuric acid method were used as a base, and the type and the number of parts of the hydrophobic treatment agent and the treatment temperature were changed as shown in Table 1. Table 1 shows physical properties of the external additive A19 measured by various measurement methods for the hydrophobized fine alumina particles.

TABLE 1

| | | | | | Number- |
|---|---|---|---|---|---|
| | | | | Treatment | average |
| External | Type of external | | Treatment | temperature | particle |
| additive A | additive base | Hydrophobic treatment agent | parts (parts) | (° C.) | diameter (nm) |
| A1 | Alumina | Dimethyl silicone oil | 10.0 | 300 | 35 |
| A2 | Alumina | Octyltrimethoxysilane | 6.0 | 200 | 35 |
| A3 | Alumina | Decyltrimethoxysilane | 6.0 | 200 | 35 |
| A4 | Alumina | Dodecyltrimethoxysilane | 12.0 | 200 | 35 |
| A5 | Alumina | Hexyltrimethoxysilane | 5.0 | 200 | 35 |
| A6 | Alumina | Dodecyltrimethoxysilane | 20.0 | 200 | 35 |
| A7 | Alumina | Isobutyltrimethoxysilane | 6.0 | 200 | 35 |
| A8 | Alumina | Isobutyltrimethoxysilane | 2.0 | 200 | 35 |
| A9 | Alumina | Propyltrimethoxysilane | 2.0 | 200 | 35 |
| A10 | Alumina | Tetradecyltrimethoxysilane | 15.0 | 200 | 35 |
| A11 | Alumina | Carbinol-modified silicone oil | 8.0 | 300 | 35 |
| A12 | Alumina | Stearic acid | 8.0 | 180 | 35 |
| A13 | Alumina | Dimethyl silicone oil | 2.0 | 300 | 100 |
| A14 | Alumina | Dimethyl silicone oil | 20.0 | 300 | 20 |
| A15 | Alumina | Dimethyl silicone oil | 1.5 | 300 | 300 |
| A16 | Alumina | Dimethyl silicone oil | 30.3 | 300 | 15 |
| A17 | Alumina | Dimethyl silicone oil | 1.0 | 300 | 350 |
| A18 | Alumina | Dimethyl silicone oil | 32.0 | 300 | 12 |
| A19 | Titania | Dimethyl silicone oil | 15.0 | 300 | (35) |
| A20 | Alumina | Isobutyltrimethoxysilane | 1.5 | 200 | 35 |
| A21 | Alumina | Dimethyl silicone oil | 15.0 | 300 | 35 |
| A22 | Alumina | Stearic acid | 6.0 | 180 | 35 |
| A23 | Alumina | Isobutyltrimethoxysilane | 8.0 | 200 | 35 |
| A24 | Alumina | Tetradecyltrimethoxysilane | 10.0 | 200 | 35 |

| | | | Rate of atoms | | Mass change |
|---|---|---|---|---|---|
| | | Volume | originated from the | | rate/specific |
| External | | resistivity | fine base particles | Carbon content | surface area |
| additive A | Hydrophobicity | (Ω · cm) | (atomic %) | (mass %) | (% g/m²) |
| A1 | 70 | 2.0 × 10¹¹ | 50 | 3.2 | 0.020 |
| A2 | 70 | 2.2 × 10¹¹ | 45 | 2.5 | 0.016 |
| A3 | 75 | 1.2 × 10¹¹ | 40 | 2.9 | 0.042 |
| A4 | 80 | 2.8 × 10¹⁰ | 65 | 6.0 | 0.098 |
| A5 | 60 | 4.4 × 10¹¹ | 35 | 1.9 | 0.005 |
| A6 | 85 | 4.5 × 10¹⁰ | 62 | 7.4 | 0.075 |
| A7 | 75 | 6.6 × 10¹¹ | 30 | 1.8 | 0.004 |
| A8 | 55 | 5.6 × 10¹¹ | 35 | 0.5 | 0.050 |
| A9 | 50 | 3.2 × 10¹¹ | 32 | 0.5 | 0.052 |
| A10 | 90 | 5.0 × 10¹⁰ | 70 | 8.5 | 0.140 |
| A11 | 65 | 1.0 × 10¹² | 35 | 2.8 | 0.105 |
| A12 | 90 | 1.0 × 10⁸ | 70 | 6.2 | 0.060 |
| A13 | 60 | 4.0 × 10¹¹ | 40 | 0.7 | 0.088 |
| A14 | 85 | 8.0 × 10¹⁰ | 60 | 7.8 | 0.044 |
| A15 | 55 | 4.5 × 10¹¹ | 35 | 0.5 | 0.050 |
| A16 | 90 | 2.4 × 10¹⁰ | 65 | 10.0 | 0.042 |
| A17 | 50 | 8.0 × 10¹¹ | 30 | 0.4 | 0.064 |
| A18 | 90 | 2.0 × 10⁹ | 70 | 10.6 | 0.052 |
| A19 | (70) | (1.0 × 10¹¹) | (60) | (5.4 | (0.035) |
| A20 | 45 | 1.6 × 10¹⁰ | 45 | 0.4 | 0.088 |
| A21 | 80 | 1.4 × 10¹² | 45 | 5.5 | 0.008 |
| A22 | 85 | 9.6 × 10⁷ | 70 | 4.7 | 0.120 |
| A23 | 80 | 8.2 × 10¹¹ | 28 | 2.3 | 0.003 |
| A24 | 80 | 5.6 × 10⁹ | 72 | 5.6 | 0.180 |

### <Production Example of Toner Particles 1>

### “Synthesis of Polyester Resin 1”

Ethylene oxide adduct of bisphenol A (ethylene oxide/bisphenol A=2/1 (mol/mol)): 9 parts by mole
Propylene oxide adduct of bisphenol A (propylene oxide/bisphenol A=2/1 (mol/mol)): 95 parts by mole

| | |
|---|---|
| Terephthalic acid | 50 parts by mole |
| Fumaric acid | 30 parts by mole |
| Dodecenylsuccinic acid | 25 parts by mole |

A flask equipped with an agitator, a nitrogen inlet, a temperature sensor, and a rectifying column was charged with these monomers and was heated to 195° C. for 1 hour. It was confirmed that the reaction system was uniformly stirred. 1.0 part of tin distearate was added to 100 parts of the monomers. The temperature was increased from 195° C. to 250° C. over 5 hours while produced water was distilled off, and a dehydration condensation reaction was performed at 250° C. for another 2 hours.

A polyester resin 1 thus produced had a glass transition temperature of 60.2° C., an acid value of 16.8 mgKOH/g, a hydroxyl value of 28.2 mgKOH/g, a weight-average molecular weight of 11200, and a number-average molecular weight of 4100.

### “Synthesis of Polyester Resin 2”

Ethylene oxide adduct of bisphenol A (ethylene oxide/bisphenol A=2/1 (mol/mol)): 48 parts by mole
Propylene oxide adduct of bisphenol A (propylene oxide/bisphenol A=2/1 (mol/mol)): 48 parts by mole

| | |
|---|---|
| Terephthalic acid | 65 parts by mole |
| Dodecenylsuccinic acid | 30 parts by mole |

A flask equipped with an agitator, a nitrogen inlet, a temperature sensor, and a rectifying column was charged with these monomers and was heated to 195° C. for 1 hour. It was confirmed that the reaction system was uniformly stirred. 0.7 parts of tin distearate was added to 100 parts of the monomers. The temperature was increased from 195° C. to 240° C. over 5 hours while produced water was distilled off, and a dehydration condensation reaction was performed at 240° C. for another 2 hours. The temperature was then decreased to 190° C. 5 parts by mole of trimellitic anhydride was gradually added, and the reaction was continued at 190ºC for 1 hour.

A polyester resin 2 thus produced had a glass transition temperature of 55.2° C., an acid value of 14.3 mgKOH/g, a hydroxyl value of 24.1 mgKOH/g, a weight-average molecular weight of 43600, and a number-average molecular weight of 6200.

### “Preparation of Resin Particle Dispersion Liquid 1”

| | |
|---|---|
| Polyester resin 1 | 100 parts |
| Methyl ethyl ketone | 50 parts |
| Isopropyl alcohol | 20 parts |

A vessel was charged with the methyl ethyl ketone and the isopropyl alcohol. The resin was then gradually charged into the vessel and was completely dissolved while stirring. Thus, a polyester resin 1 solution was produced. The temperature of the vessel containing the polyester resin 1 solution was set to 65° C., a total of 5 parts of 10% aqueous ammonia was gradually added dropwise while stirring, and 230 parts of deionized water was gradually added dropwise at 10 ml/min for phase inversion emulsification. Furthermore, the pressure was reduced with an evaporator to remove the solvent and produce a resin particle dispersion liquid 1 of the polyester resin 1. The resin particles had a volume-average particle diameter of 135 nm. The resin particle solid content was adjusted with ion-exchanged water to be 20%.

### “Preparation of Resin Particle Dispersion Liquid 2”

| | |
|---|---|
| Polyester resin 2 | 100 parts |
| Methyl ethyl ketone | 50 parts |
| Isopropyl alcohol | 20 parts |

A vessel was charged with the methyl ethyl ketone and the isopropyl alcohol. The materials were then gradually charged into the vessel and were completely dissolved while stirring. Thus, a polyester resin 2 solution was produced. The temperature of the vessel containing the polyester resin 2 solution was set to 40° C., a total of 3.5 parts of 10% aqueous ammonia was gradually added dropwise while stirring, and 230 parts of deionized water was gradually added dropwise at 10 ml/min for phase inversion emulsification. Furthermore, the pressure was reduced to remove the solvent and produce a resin particle dispersion liquid 2 of the polyester resin 2. The resin particles had a volume-average particle diameter of 155 nm. The resin particle solid content was adjusted with ion-exchanged water to be 20%.

### “Preparation of Colorant Particle Dispersion Liquid”

Copper phthalocyanine (Pigment Blue 15:3) 45 parts
Ionic surfactant Neogen RK (manufactured by Dai-ichi Kogyo Seiyaku Co., Ltd.) 5 parts

| | |
|---|---|
| Deionized water | 190 parts |

These components were mixed and dispersed for 10 minutes with a homogenizer (Ultra-Turrax manufactured by IKA), and were then dispersed at a pressure of 250 MPa for 20 minutes using Ultimizer (a counter collision type wet mill manufactured by Sugino Machine Ltd.) to produce a colorant particle dispersion liquid with a volume-average particle diameter of 120 nm and a solid content of 20%.

### “Preparation of Release Agent Particle Dispersion Liquid”

Release agent (hydrocarbon wax, melting point: 79° C.) 15 parts
Ionic surfactant Neogen RK (manufactured by Dai-ichi Kogyo Seiyaku Co., Ltd.) 2 parts

| | |
|---|---|
| Deionized water | 240 parts |

These materials were well-dispersed at 100° C. with IKA Ultra-Turrax T50 and were dispersed at 115° C. for 1 hour with a pressure discharge type Gaulin homogenizer. The resulting release agent particle dispersion liquid had a volume-average particle diameter of 160 nm and a solid content of 20%.

### “Production of Toner Particles 1”

| | |
|---|---|
| Resin particle dispersion liquid 1 | 500 parts |
| Resin particle dispersion liquid 2 | 400 parts |
| Colorant particle dispersion liquid | 50 parts |
| Release agent particle dispersion liquid | 80 parts |

First, in a core-forming step, these materials were mixed in a round stainless steel flask. The mixture was then dispersed with a homogenizer Ultra-Turrax T50 (manufactured by IKA) at 5000 r/min for 10 minutes. 10 parts of 0.5% by mass aqueous aluminum chloride was added at 30° C. with stirring over 10 minutes. The pH of the mixture was adjusted to 3.0 with 1.0% aqueous nitric acid. The mixture was heated to 58° C. in a heating water bath while appropriately adjusting the rotation speed at which the mixture was stirred with stirring blades. The volume-average particle diameter of the resulting agglomerate was appropriately checked with a Coulter Multisizer III. When an agglomerate (core) of 5.0 μm was formed, the following materials were added and further stirred for 1 hour to form a shell in a shell-forming step.

| | |
|---|---|
| Resin particle dispersion liquid 1 | 40 parts |
| Deionized water | 300 parts |
| 10.0% by mass aqueous borax | 19 parts |

(borax; sodium tetraborate decahydrate manufactured by FUJIFILM Wako Pure Chemical Corporation)

The pH was then adjusted to 9.0 (adjusted pH) using 5% aqueous sodium hydroxide, and the mixture was heated to 89° C. with stirring. The heating was stopped when a desired surface profile was obtained. The product was then cooled to 25° C., was subjected to filtration and solid-liquid separation, and was washed with deionized water. The washing was followed by drying with a vacuum dryer to prepare toner particles 1 with a weight-average particle diameter (D4) of 6.1 μm. Table 2 shows physical properties of the toner particles 1.

### <Production Example of Toner Particles 2 to 8 and 11>

Toner particles 2 to 8 and 11 were produced in the same manner as the toner particles 1 except that the formulation and conditions were changed as shown in Table 2. Table 2 shows physical properties of the toner particles 2 to 8 and 11.

### <Production Example of Toner Particles 9>

710 parts of deionized water and 850 parts of 0.1 mol/l aqueous Na₃PO₄ in a four-neck vessel were maintained at 60° C. while stirring at 12,000 rpm using a TK homomixer. 68 parts of 1.0 mol/l aqueous CaCl₂) was gradually added to the mixture to prepare an aqueous dispersion medium containing a fine poorly water-soluble dispersion stabilizer Ca₃(PO₄)₂.

| | |
|---|---|
| Styrene | 76 parts |
| n-butyl acrylate | 24 parts |

C.I. Pigment Blue 15:3 manufactured by Dainichiseika Color & Chemicals Mfg. Co., Ltd. 6.5 parts

| | |
|---|---|
| Polyester resin (1) | 5 parts |

(terephthalic acid-propylene oxide-modified bisphenol A (2 mol adduct, mole ratio=51:50), acid value=10 mgKOH/g, glass transition point=70° C., Mw=10500, Mw/Mn=3.20)

| | |
|---|---|
| Negative charge control agent | 0.4 parts |

(3,5-di-tert-butylsalicylic acid aluminum compound)
Fischer-Tropsch wax (maximum endothermic peak temperature=75° C.) 7.5 parts
10.0% by mass aqueous borax 19.0 parts

These materials were stirred with an attritor for 3 hours to disperse the components in the polymerizable monomers and prepare a monomer mixture. 10.0 parts of a polymerization initiator 1,1,3,3-tetramethylbutylperoxy 2-ethylhexanoate (toluene solution 50%) was added to the monomer mixture to prepare a polymerizable monomer composition.

The polymerizable monomer composition was introduced into the aqueous dispersion medium and was granulated for 5 minutes while maintaining a stirrer at a rotation speed of 10,000 rpm. A high-speed agitator was then replaced with a propeller stirrer, and the internal temperature was increased to 70° C. A reaction was performed for 6 hours while slowly stirring.

The vessel was then heated to 80° C., was held for 4 hours, and was then gradually cooled to 30° C. at a cooling rate of 1° C./min to prepare a slurry. Diluted hydrochloric acid was added to the vessel containing the slurry to remove the dispersion stabilizer. After filtration, washing, and drying, toner particles 9 were produced. Table 2 shows physical properties of the toner particles 9.

### <Production Example of Toner Particles 10>

| | |
|---|---|
| Polyester resin 1 | 60.0 parts |
| Polyester resin 2 | 40.0 parts |
| Copper phthalocyanine pigment | 6.5 parts |
| (Pigment Blue 15:3) | |
| Release agent (hydrocarbon wax, | 5.0 parts |
| melting point: 79° C.) | |
| Plasticizer (ethylene glycol distearate) | 15.0 parts |

Boric acid powder (manufactured by FUJIFILM Wako Pure Chemical Corporation) 1.5 parts

These materials were pre-mixed with an FM mixer (manufactured by Nippon Coke & Engineering Co., Ltd.) and were then melt-kneaded with a twin-screw extruder (PCM-30 manufactured by Ikegai Corporation). The kneaded product was cooled and was coarsely ground with a hammer mill, and 130 parts of ethyl acetate was added thereto. The product was heated to 80° C., was stirred with T.K. homomixer (manufactured by Tokushu Kika Kogyo Co., Ltd.) at a rotation speed of 5000 rpm for 1 hour, and was then cooled to 30° C. to prepare a solution.

Another vessel was charged with 400 parts of water and 5 parts of Eleminol MON-7 (manufactured by Sanyo Chemical Industries, Ltd.), was held at 30° C., was charged with 100 parts of the solution while stirring with T.K. Homomixer (manufactured by Tokushu Kika Kogyo Co., Ltd.) at a rotation speed of 13000 rpm, and was then further stirred for 20 minutes to prepare a slurry. The slurry was subjected to solvent removal with gentle stirring at 30° C. under reduced pressure for 8 hours, was aged at 45° C. for 4 hours, and was then washed, filtered, and dried to produce toner particles 10. Table 2 shows physical properties of the toner particles 10.

TABLE 2

| | | | | | | | | | | Ratio I_{B}/I_{C} |
|---|---|---|---|---|---|---|---|---|---|---|
| | | | | | | | | Intensity | | of peak I_{B} |
| | | Parts of | | | | Weight- | Intensity of | derived from | | derived from |
| | | aqueous | | | | average | aluminum in | boric acid in | Detection of | boric acid to |
| | Tonar | aluminum | | | | particle | X-ray | X-ray | peak derived | peak I_{C} derived |
| Tonar | production | chloride | Parts of boric | | Adjusted | diameter | fluorescence | fluorescence | from boric | from carbonyl |
| particles | method | to be added | acid to be added | | pH | D4 (μm) | (kcps) | (kcps) | acid | group |
| 1 | Emulsion | 10.0 | 10.0% | 19.0 | 9.0 | 6.1 | 0.12 | 0.15 | Yes | 0.14 |
| | aggregation | | by mass | | | | | | | |
| | | | aqueous | | | | | | | |
| | | | borax | | | | | | | |
| 2 | Emulsion | 0.0 | 10.0% | 57.0 | 9.0 | 6.2 | 0.00 | 0.30 | Yes | 0.20 |
| | aggregation | | by mass | | | | | | | |
| | | | aqueous | | | | | | | |
| | | | borax | | | | | | | |
| 3 | Emulsion | 0.0 | 10.0% | 9.0 | 9.0 | 6.2 | 0.00 | 0.10 | Yes | 0.10 |
| | aggregation | | by mass | | | | | | | |
| | | | aqueous | | | | | | | |
| | | | borax | | | | | | | |
| 4 | Emulsion | 0.0 | 40.0% | 51.0 | 8.8 | 6.2 | 0.00 | 0.60 | Yes | 0.30 |
| | aggregation | | by mass | | | | | | | |
| | | | aqueous | | | | | | | |
| | | | borax | | | | | | | |
| 5 | Emulsion | 0.0 | 40.0% | 51.0 | 8.6 | 6.2 | 0.00 | 0.60 | Yes | 0.33 |
| | aggregation | | by mass | | | | | | | |
| | | | aqueous | | | | | | | |
| | | | borax | | | | | | | |
| 6 | Emulsion | 0.0 | 40.0% | 56.0 | 9.0 | 6.3 | 0.00 | 0.64 | Yes | 0.28 |
| | aggregation | | by mass | | | | | | | |
| | | | aqueous | | | | | | | |
| | | | borax | | | | | | | |
| 7 | Emulsion | 0.0 | 10.0% | 9.0 | 9.2 | 6.3 | 0.00 | 0.10 | Yes | 0.01 |
| | aggregation | | by mass | | | | | | | |
| | | | aqueous | | | | | | | |
| | | | borax | | | | | | | |
| 8 | Emulsion | 0.0 | 10.0% | 7.0 | 8.6 | 6.2 | 0.00 | 0.08 | Yes | 0.02 |
| | aggregation | | by mass | | | | | | | |
| | | | aqueous | | | | | | | |
| | | | borax | | | | | | | |
| 9 | Suspension | — | 10.0% | 19.0 | — | 6.4 | 0.16 | 0.15 | Yes | 0.04 |
| | method | | by mass | | | | | | | |
| | | | aqueous | | | | | | | |
| | | | borax | | | | | | | |
| 10 | Pulverization | — | Borax | 1.5 | — | 7.0 | 0.00 | 0.14 | Yes | 0.03 |
| | method | | powder | | | | | | | |
| 11 | Emulsion | 10.0 | — | 0.0 | 9.0 | 6.3 | 0.14 | 0.00 | No | — |
| | aggregation | | | | | | | | | |

### <Production Example of Toner 1>

The toner particles 1 were subjected to external addition. Toner 1 was prepared by dry-mixing 100.0 parts of the toner particles 1, 0.5 parts of the external additive A1, 0.8 parts of fine silica particles (surface-treated with 20% by mass of hexamethyldisilazane, primary particle diameter: 16 nm), and 2.0 parts of titania particles (FTL-100 manufactured by Ishihara Sangyo Kaisha, Ltd., long diameter: 1.7 μm, aspect ratio: 10) using a Henschel mixer (manufactured by Mitsui Mining Co., Ltd.) at a peripheral speed of 38 m/s for 5 minutes.

### <Production Examples of Toners 2 to 39>

Toners 2 to 39 were prepared in the same manner as in the production example of Toner 1 except that the types of toner particles and the external additive A and the addition amount of titania particles (FTL-100 manufactured by Ishihara Sangyo Kaisha, Ltd., long diameter: 1.7 μm, aspect ratio: 10) were changed as shown in Table 3.

TABLE 3

| | | External | | Titania |
|---|---|---|---|---|
| | | additive A | | particles |
| | Toner | | Addition | (FTL-100) |
| Toner | particles | No. | parts | Addition parts |
| 1 | 1 | 1 | 0.5 | 2.0 |
| 2 | 1 | 2 | 0.5 | 2.0 |
| 3 | 1 | 3 | 0.5 | 2.0 |
| 4 | 1 | 4 | 0.5 | 0.0 |
| 5 | 1 | 5 | 0.5 | 0.0 |
| 6 | 1 | 6 | 0.5 | 0.0 |
| 7 | 1 | 7 | 0.5 | 0.0 |
| 8 | 1 | 8 | 0.5 | 0.0 |
| 9 | 1 | 9 | 0.5 | 0.0 |
| 10 | 1 | 10 | 0.5 | 0.0 |
| 11 | 1 | 11 | 0.5 | 0.0 |
| 12 | 1 | 12 | 0.5 | 0.0 |
| 13 | 1 | 13 | 0.2 | 0.0 |
| 14 | 1 | 14 | 1.0 | 0.0 |
| 15 | 1 | 15 | 0.1 | 0.0 |
| 16 | 1 | 16 | 5.0 | 0.0 |
| 17 | 1 | 17 | 6.0 | 0.0 |
| 18 | 1 | 18 | 5.0 | 0.0 |
| 19 | 1 | 15 | 0.1 | 0.0 |
| 20 | 1 | 15 | 5.0 | 0.0 |
| 21 | 1 | 15 | 0.1 | 0.0 |
| 22 | 1 | 15 | 5.0 | 0.0 |
| 23 | 1 | 15 | 0.1 | 0.0 |
| 24 | 2 | 15 | 5.0 | 0.0 |
| 25 | 3 | 15 | 5.0 | 0.0 |
| 26 | 4 | 15 | 5.0 | 0.0 |
| 27 | 5 | 15 | 5.0 | 0.0 |
| 28 | 6 | 15 | 5.0 | 0.0 |
| 29 | 7 | 15 | 5.0 | 0.0 |
| 30 | 8 | 15 | 5.0 | 0.0 |
| 31 | 9 | 15 | 5.0 | 0.0 |
| 32 | 10 | 15 | 5.0 | 0.0 |
| 33 | 1 | 19 | 0.5 | 0.0 |
| 34 | 1 | 20 | 0.5 | 0.0 |
| 35 | 1 | 21 | 0.5 | 0.0 |
| 36 | 1 | 22 | 0.5 | 0.0 |
| 37 | 1 | 23 | 0.5 | 0.0 |
| 38 | 1 | 24 | 0.5 | 0.0 |
| 39 | 11 | 1 | 0.5 | 0.0 |

### Exemplary Embodiment 1

Toner 1 was subjected to the following evaluation.

### <Evaluation 1> Evaluation of Regulatory Failure in Low-Temperature and Low-Humidity Environment

A modified apparatus produced by modifying a commercially available laser printer “LBP-9660Ci (manufactured by CANON KABUSHIKI KAISHA)” to have a process speed of 325 mm/s was used as an image-forming apparatus. A commercially available toner cartridge (cyan) (manufactured by CANON KABUSHIKI KAISHA) was used as a process cartridge.

Product toner was removed from the cartridge, and the cartridge was cleaned by air blowing and was then filled with 270 g of toner to be evaluated. Product toner was removed from yellow, magenta, and black stations, and the evaluation was performed by inserting yellow, magenta, and black cartridges in which a remaining toner quantity detection mechanism was disabled.

Next, an electrophotographic apparatus and a process cartridge were left in an environment of 15° C. and 10% RH for 48 hours to be ready for use in the measurement environment. Subsequently, in the low-temperature and low-humidity environment (15° C./10% RH), 25,000 sheets of an image with a printing ratio of 1.0% were output on the central portion of a letter-size Business 4200 sheet (manufactured by Xerox Corporation, 75 g/m²) with a margin of 50 mm on the left and right sides, and a halftone image with a toner coverage of 0.20 mg/cm² was then output to evaluate the number of spotted streaks and toner lumps on the halftone image. The evaluation was made in accordance with the following evaluation criteria, and B or higher was judged to be good.

### (Evaluation Criteria)

A: No streak or toner lump.
B: No spotted streak but two or three small toner lumps.
C: Some spotted streaks at an end portion or four or five small toner lumps.
D: Spotted streaks over the entire surface, 5 or more small toner lumps, or an apparent toner lump.

### <Evaluation 2> Evaluation of Chargeability in High-Temperature and High-Humidity Environment

0.50 g of the toner and 9.50 g of magnetic ferrite carrier particles (number-average particle diameter: 35 μm) coated with a silicone resin are placed in a 50-cc plastic bottle as a developing agent, are left for 24 hours in an environment of 30° C. and 80% RH, and are shaken with a Yayoi shaker at 200 rpm for 120 seconds in the above environment. The amount of electrical charge on the toner is then measured as described below using E-Spart Analyzer manufactured by Hosokawa Micron Corporation.

### (Measurement Conditions of E-Spart Analyzer)

Number of toner particles to be measured: 3000
PM voltage: −460 V
Field voltage: 100 V
Suction flow rate at measurement portion: 6.6×10⁻⁶ m³/s
Rotation speed of two-component feeder: 0.025 to 0.050 s⁻¹
Direct-current voltage of rectifier for electromagnetic coil: 100 V
Blowing pressure of nitrogen gas: 20 kPa
Blowing time of nitrogen gas: 1 second
Blowing interval of nitrogen gas: 3 seconds

The developing agent is held by a two-component feeder (a developing agent holding table with a turntable having a magnet) attached to the E-Spart Analyzer. Nitrogen gas is then sprayed from an air nozzle onto the developing agent held by magnetic force on the two-component feeder to blow off only toner, and only the toner is sucked into a measurement portion of the E-Spart Analyzer through a sample inlet tube located below the two-component feeder. The dwell time (ms), the particle diameter d (μm), and the amount of electrical charge q (fC) are measured for each particle. The charge distribution can be determined from this data.

On the basis of the charge distribution, the chargeability was evaluated in accordance with the following evaluation criteria. C or higher was judged to be good.

### (Evaluation Criteria)

A: 90% or more of the toner has a charge amount of −2.0 μC/g or less.
B: 80% or more and less than 90% of the toner has a charge amount of −2.0 μC/g or less.
C: 70% or more and less than 80% of the toner has a charge amount of −2.0 μC/g or less.
F: Less than 70% of the toner has a charge amount of −2.0 μC/g or less.

### <Evaluation 3> Evaluation of Charge Retention in High-Temperature and High-Humidity Environment

The charge distribution was measured by the method of Evaluation 2, and the initial average amount of electrical charge (μC/g) was calculated.

A plastic bottle containing a developing agent was left in a high-temperature and high-humidity environment (30° C., 80% RH) for 48 hours in the same manner as described above, and the average amount of electrical charge (μC/g) after being left was then measured with the E-Spart Analyzer manufactured by Hosokawa Micron Corporation in the same manner as described above.

A retention rate of the average amount of electrical charge was calculated by dividing the average amount of electrical charge after being left by the initial average amount of electrical charge and was evaluated in accordance with the following evaluation criteria. C or higher was judged to be good.

### (Evaluation Criteria)

A: A retention rate of 90% or more
B: A retention rate of 80% or more and less than 90%
C: A retention rate of 70% or more and less than 80%
D: A retention rate of less than 70%

### <Evaluation 4> Evaluation of Transferability in High-Temperature and High-Humidity Environment

An electrophotographic apparatus and a process cartridge were prepared by the method of Evaluation 1 and were left in the environment of 30° C. and 80% RH for 48 hours to be ready for use in the measurement environment. Subsequently, in the high-temperature and high-humidity environment (30° C./80% RH), 1000 sheets of an image with a printing ratio of 1.0% were output on the central portion of a letter-size Business 4200 sheet (manufactured by Xerox Corporation, 75 g/m²) with a margin of 50 mm on the left and right sides, and a solid image with a toner coverage of 0.40 mg/cm² was then output. A transparent polyester adhesive tape was attached to untransferred toner on an electrostatic latent image bearing member at the solid-image-forming period and was then peeled off. A reflectivity difference was calculated by subtracting the reflectivity of the adhesive tape alone on paper from the reflectivity of the peeled adhesive tape on the paper and was evaluated as initial transferability.

Furthermore, after 24,000 sheets of an image with a printing ratio of 1.0% were output, the transferability after durability was evaluated in the same manner as in the evaluation of transferability described above.

The evaluation was made in accordance with the following evaluation criteria, and C or higher was judged to be good. The reflectivity was measured with a reflectometer (Reflectometer Model TC-6DS manufactured by Tokyo Denshoku Co., Ltd.).

### (Evaluation Criteria)

A: A reflectivity difference of less than 5.0%
B: A reflectivity difference of 5.0% or more and less than 10.0%
C: A reflectivity difference of 10.0% or more and less than 15.0%
D: A reflectivity difference of 15.0% or more

### <Evaluation 5> Evaluation of Charge Build-Up in High-Temperature and High-Humidity Environment

In the same manner as in Evaluation 2, 0.50 g of toner and 9.50 g of a carrier as a developing agent in a 50-cc plastic bottle were left in the environment of 30° C. and 80% RH for 24 hours. In the environment described above, the plastic bottle was shaken with the Yayoi shaker at 200 rpm, and the average amounts of electrical charge at shaking times of 20 seconds and 120 seconds were measured with the E-Spart Analyzer manufactured by Hosokawa Micron Corporation in the same manner as in Evaluation 2.

A value obtained by dividing the average amount of electrical charge at a shaking time of 20 seconds by the average amount of electrical charge at a shaking time of 120 seconds was calculated as a measure of the charge build-up and was evaluated in accordance with the following evaluation criteria. C or higher was judged to be good.

### (Evaluation Criteria)

A: A measure of charge build-up of 85% or more
B: A measure of charge build-up of 70% or more and less than 85%
C: A measure of charge build-up of 55% or more and less than 70%
D: A measure of charge build-up of less than 55%

### Exemplary Embodiments 2 to 32

The evaluation was performed in the same manner as in Exemplary

Embodiment 1 except that Toners 2 to 32 were used instead of Toner 1. Table 4 shows the evaluation results.

### Comparative Examples 1 to 7

The evaluation was performed in the same manner as in Exemplary Embodiment 1 except that Toners 33 to 39 were used instead of Toner 1. Table 4 shows the evaluation results.

TABLE 4

| | Toner | Regulatory | | | Charge | | Transferability | | Transferability | | Charge | |
|---|---|---|---|---|---|---|---|---|---|---|---|---|
| | No. | failure | Chargeability | | retention | | (initial) | | (after durability) | | build-up | |
| Exemplary embodiment 1 | 1 | A | A | 98 | A | 97 | A | 3.2 | A | 4.2 | A | 90 |
| Exemplary embodiment 2 | 2 | A | A | 97 | A | 96 | A | 3.7 | A | 4.6 | A | 88 |
| Exemplary embodiment 3 | 3 | A | A | 95 | A | 96 | A | 4.2 | A | 4.7 | A | 88 |
| Exemplary embodiment 4 | 4 | A | A | 92 | A | 96 | A | 4.4 | B | 5.2 | B | 82 |
| Exemplary embodiment 5 | 5 | A | A | 91 | A | 97 | A | 4.6 | B | 5.4 | B | 75 |
| Exemplary embodiment 6 | 6 | A | A | 93 | A | 95 | A | 4.8 | B | 6.0 | B | 77 |
| Exemplary embodiment 7 | 7 | A | A | 90 | A | 95 | B | 5.6 | B | 6.2 | C | 69 |
| Exemplary embodiment 8 | 8 | A | B | 87 | A | 92 | B | 6.4 | B | 6.8 | B | 76 |
| Exemplary embodiment 9 | 9 | A | B | 85 | B | 84 | B | 7.3 | B | 7.8 | B | 78 |
| Exemplary embodiment 10 | 10 | A | A | 90 | A | 93 | B | 5.4 | B | 6.0 | C | 65 |
| Exemplary embodiment 11 | 11 | B | A | 90 | A | 95 | B | 5.7 | B | 6.1 | C | 66 |
| Exemplary embodiment 12 | 12 | A | B | 86 | B | 82 | B | 7.3 | B | 7.7 | B | 78 |
| Exemplary embodiment 13 | 13 | A | B | 86 | B | 86 | B | 6.9 | B | 8.4 | B | 76 |
| Exemplary embodiment 14 | 14 | A | B | 88 | B | 83 | B | 7.4 | B | 7.9 | B | 76 |
| Exemplary embodiment 15 | 15 | B | B | 88 | B | 87 | B | 6.5 | B | 9.2 | B | 78 |
| Exemplary embodiment 16 | 16 | A | B | 86 | B | 80 | B | 7.3 | B | 7.7 | B | 78 |
| Exemplary embodiment 17 | 17 | A | B | 84 | B | 80 | C | 10.6 | C | 10.9 | B | 76 |
| Exemplary embodiment 18 | 18 | A | A | 94 | A | 96 | A | 4.3 | B | 6.6 | A | 87 |
| Exemplary embodiment 19 | 19 | A | A | 92 | A | 95 | A | 4.8 | B | 6.8 | A | 87 |
| Exemplary embodiment 20 | 20 | A | A | 92 | B | 87 | B | 6.3 | B | 9.3 | A | 86 |
| Exemplary embodiment 21 | 21 | A | B | 83 | A | 96 | B | 5.0 | B | 8.9 | A | 86 |
| Exemplary embodiment 22 | 22 | B | A | 90 | B | 84 | B | 6.3 | C | 10.7 | B | 76 |
| Exemplary embodiment 23 | 23 | A | B | 87 | B | 87 | B | 8.2 | C | 12.1 | B | 75 |
| Exemplary embodiment 24 | 24 | A | B | 88 | C | 78 | B | 7.4 | B | 9.8 | A | 85 |
| Exemplary embodiment 25 | 25 | A | B | 82 | C | 77 | B | 9.6 | C | 11.7 | A | 85 |
| Exemplary embodiment 26 | 26 | A | B | 81 | C | 78 | B | 8.4 | C | 11.2 | B | 75 |
| Exemplary embodiment 27 | 27 | A | B | 80 | C | 76 | B | 9.5 | C | 12.4 | C | 68 |
| Exemplary embodiment 28 | 28 | A | C | 78 | C | 78 | B | 9.8 | C | 12.5 | B | 73 |
| Exemplary embodiment 29 | 29 | A | B | 82 | C | 78 | B | 8.0 | C | 11.8 | C | 69 |
| Exemplary embodiment 30 | 30 | A | C | 76 | C | 79 | B | 9.8 | C | 12.7 | B | 75 |
| Exemplary embodiment 31 | 31 | A | B | 84 | C | 78 | B | 9.0 | C | 12.6 | B | 76 |
| Exemplary embodiment 32 | 32 | A | C | 78 | C | 72 | B | 8.8 | C | 11.8 | B | 74 |
| Comparative example 1 | 33 | A | D | 68 | C | 76 | D | 15.6 | D | 16.2 | C | 68 |
| Comparative example 2 | 34 | B | C | 72 | D | 64 | D | 15.7 | D | 16.6 | C | 63 |
| Comparative example 3 | 35 | D | D | 67 | B | 86 | D | 15.2 | D | 15.8 | C | 62 |
| Comparative example 4 | 36 | B | D | 65 | D | 62 | D | 16.7 | D | 17.4 | D | 54 |
| Comparative example 5 | 37 | C | D | 66 | D | 65 | D | 16.2 | D | 16.8 | D | 54 |
| Comparative example 6 | 38 | B | D | 62 | D | 94 | D | 16.4 | D | 17.1 | D | 53 |
| Comparative example 7 | 39 | A | D | 60 | B | 87 | D | 15.8 | D | 16.8 | D | 50 |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-209745 filed Dec. 27, 2022 and No. 2023-200925 filed Nov. 28, 2023, which are hereby incorporated by reference herein in their entirety.

What is claimed is:

1. A toner comprising:
a toner particle containing a binder resin; and
an external additive, wherein
a peak corresponding to boric acid is detected in ATR-IR analysis of the toner particle using germanium as an ATR crystal in an ATR method,
the external additive contains a hydrophobized fine alumina particle produced by surface-treating a fine alumina particle, which is a fine base particle, with a hydrophobic treatment agent,
the hydrophobized fine alumina particle has a hydrophobicity of 50 or more and 90 or less,
the hydrophobized fine alumina particle has a volume resistivity of 1.0×10⁸ Ω·cm or more and 1.0×10¹² Ω·cm or less, and
a rate of atoms originated from the fine base particle in the hydrophobized fine alumina particle is 30 atomic % or more and 70 atomic % or less.

2. The toner according to claim 1, wherein boron derived from the boric acid has an intensity of 0.10 kcps or more and 0.60 kcps or less in X-ray fluorescence measurement of the toner particle.

3. The toner according to claim 1, wherein the hydrophobized fine alumina particle has a number-average particle diameter of 15 nm or more and 300 nm or less.

4. The toner according to claim 1, wherein the hydrophobized fine alumina particle content is 0.1 parts by mass or more and 5.0 parts by mass or less per 100 parts by mass of the toner particles.

5. The toner according to claim 1, wherein the hydrophobic treatment agent for the hydrophobized fine alumina particle is a silicon compound with a hydrocarbon moiety.

6. The toner according to claim 5, wherein the hydrophobized fine alumina particle has a carbon content of 0.5% by mass or more and 10.0% by mass or less.

7. The toner according to claim 5, wherein the hydrophobic treatment agent is dimethyl silicone oil.

8. The toner according to claim 5, wherein the hydrophobic treatment agent is at least one selected from the group consisting of silane compounds represented by the following formula (1) and hydrolysates of the silane compounds, 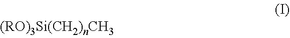
wherein R denotes a methyl group or an ethyl group, and n denotes an integer of 5 or more and 11 or less.

9. The toner according to claim 1, wherein when the hydrophobized fine alumina particle is left for 24 hours in an environment of a temperature of 30° C. and a relative humidity of 0% and is then left for 1 hour in an environment of a temperature of 30° C. and a relative humidity of 80%, a value obtained by dividing a mass change rate of the hydrophobized fine alumina particle by a specific surface area of the hydropbobized fine alumina particle (mass change rate/specific surface area) is 0.005%·g/m² or more and 0.100%·g/m² or less.

10. The toner according to claim 1, wherein a peak I_{B} derived from boric acid and a peak I_{C} derived from a carbonyl group are detected in the ATR-IR analysis of the toner particle, and a ratio I_{B}/I_{C} is 0.02 or more and 0.30 or less.
